(19) United States
(12) Patent Application Publication
(10) Pub. No.: US 2025/0257294 A1
(43) Pub. Date: Aug. 14, 2025

(54) LAUNDRY DETERGENTS AND UNIT DOSE ARTICLES WITH REDUCED RESIDUE

(71) Applicant: The Procter & Gamble Company, Cincinnati, OH (US)

(72) Inventors: Lindsey HEATHCOTE, Northumberland (GB); Mark Robert SIVIK, Mason, OH (US); Philip Frank SOUTER, Morpeth Northumberland (GB); Michelle JACKSON, Newcastle Upon Tyne (GB)

(21) Appl. No.: 19/051,231

(22) Filed: Feb. 12, 2025

Related U.S. Application Data
(60) Provisional application No. 63/552,821, filed on Feb. 13, 2024.

(51) Int. Cl. C11D 17/04; C11D 1/22; C11D 1/29; C11D 3/02; C11D 3/386

(52) U.S. Cl. CPC C11D 17/044; C11D 1/22; C11D 1/29; C11D 3/02; C11D 3/386; C11D 2111/12

(57) ABSTRACT

A laundry detergent composition including a particulate material is provided. The particulate material may include one or more particles having an active component and a non-active component. The non-active component may have a dry particle size of from about 0.01 μm to about 20 μm. Unit dose articles may include a water-soluble fibrous structure and the laundry detergent composition or at least the particulate material.

### FIELD

The present disclosure relates generally to laundry detergents and unit dose articles and more specifically to laundry detergents and unit dose articles exhibiting reduced residue deposition on fabrics.

### BACKGROUND

Some detergent formulations, while effective in removing stains, may introduce undesirable residue buildup on laundered items, compromising appearance, fabric softness, and user comfort. This issue has become increasingly pronounced as consumer expectations evolve to demand not only superior cleaning efficacy but also a residue-free post-wash look and feel. The challenge lies in developing detergent compositions and convenient forms for delivering those detergent compositions that excel in stain removal while mitigating the tendency to leave behind unwanted residues on fabrics. Addressing this concern is crucial in meeting the growing preference for environmentally friendly and fabric-safe laundry solutions, aligning with the evolving standards of modern consumers.

The discussion of shortcomings and needs existing in the field prior to the present disclosure is in no way an admission that such shortcomings and needs were recognized by those skilled in the art prior to the present disclosure.

### SUMMARY

Various iterations solve the above-mentioned problems and provide compositions, articles, and methods useful for providing detergent compositions and convenient forms for delivering those detergent compositions that excel in stain removal while mitigating the tendency to leave behind unwanted residues on fabrics.

Various iterations relate to a laundry detergent composition comprising a particulate material. The particulate material may comprise at least one particle. The at least one particle may comprise an active component and a non-active component. The non-active component may have a dry particle size of from about 0.01 μm to about 20 μm. The non-active component may be only partially water soluble. Various iterations relate to a unit dose article comprising a water-soluble fibrous structure and the laundry detergent composition or at least the particulate material.

Various iterations relate to a unit dose article comprising a water-soluble fibrous structure having a plurality of layers and a plurality of particles dispersed between the plurality of layers. One, more than one, or each of the plurality of particles may comprise an active component and a non-active component. Upon exposure to water at a temperature of 5° C. to 40° C., preferably about 10° C. to about 25° C. for a time of about 5 minutes to about 60 minutes, preferably about 10 minutes to about 20 minutes, at least about 50% to about 100%, preferably about 70% to 90% of the plurality of particles may release at least some of the active component contained therein, and have a particle size of from about 0.01 μm to about 50 μm.

These and other features, aspects, and advantages of various iterations will become better understood with reference to the following description, figures, and claims.

### BRIEF DESCRIPTION OF THE DRAWINGS

Many aspects of this disclosure can be better understood with reference to the following figures, which illustrate examples according to various iterations.

FIG. 1 is a schematic representation of a cross-sectional view of an example of a multi-ply fibrous structure.

FIG. 2 is a micro-CT scan image showing a cross-sectional view of an example of a water-soluble unit dose article.

FIG. 3 is a process for making plies of a material.

FIG. 4 is a perspective view of an iteration of a single-dose laundry detergent unit embodying a new design.

FIG. 5 is a schematic top view of a piece of test fabric with a residue deposited thereon.

FIG. 6A is a photograph of an untreated/unstained sample of C70 black fabric.

FIG. 6B is a photograph of a first replicate of a C70 black fabric after exposure to Composition 1 at 10° C.

FIG. 6C is a photograph of a second replicate of a C70 black fabric after exposure to Composition 1 at 10° C.

FIG. 6D is a photograph of a third replicate of a C70 black fabric after exposure to Composition 2 at 10° C.

FIG. 7A is a photograph of an untreated/unstained sample of C70 black fabric.

FIG. 7B is a photograph of a first replicate of a C70 black fabric after exposure to Composition 2 at 10° C.

FIG. 7C is a photograph of a second replicate of a C70 black fabric after exposure to Composition 2 at 10° C.

FIG. 7D is a photograph of a third replicate of a C70 black fabric after exposure to Composition 2 at 10° C.

FIG. 8A is a photograph of an untreated/unstained sample of C70 black fabric.

FIG. 8B is a photograph of a first replicate of a C70 black fabric after exposure to Composition 3 at 10° C.

FIG. 8C is a photograph of a second replicate of a C70 black fabric after exposure to Composition 3 at 10° C.

FIG. 8D is a photograph of a third replicate of a C70 black fabric after exposure to Composition 3 at 10° C.

FIG. 9A is a photograph of an untreated/unstained sample of C70 black fabric.

FIG. 9B is a photograph of a first replicate of a C70 black fabric after exposure to Composition 4 at 10° C.

FIG. 9C is a photograph of a second replicate of a C70 black fabric after exposure to Composition 4 at 10° C.

FIG. 9D is a photograph of a third replicate of a C70 black fabric after exposure to Composition 4 at 10° C.

FIG. 10A is a photograph of an untreated/unstained sample of C70 black fabric.

FIG. 10B is a photograph of a first replicate of a C70 black fabric after exposure to Composition 1 at 25° C.

FIG. 10C is a photograph of a second replicate of a C70 black fabric after exposure to Composition 1 at 25° C.

FIG. 10D is a photograph of a third replicate of a C70 black fabric after exposure to Composition 1 at 25° C.

FIG. 11A is a photograph of an untreated/unstained sample of C70 black fabric.

FIG. 11B is a photograph of a first replicate of a C70 black fabric after exposure to Composition 2 at 25° C.

FIG. 11C is a photograph of a second replicate of a C70 black fabric after exposure to Composition 2 at 25° C.

FIG. 11D is a photograph of a third replicate of a C70 black fabric after exposure to Composition 2 at 25° C.

FIG. 12A is a photograph of an untreated/unstained sample of C70 black fabric.

FIG. 12B is a photograph of a first replicate of a C70 black fabric after exposure to Composition 3 at 25° C.

FIG. 12C is a photograph of a second replicate of a C70 black fabric after exposure to Composition 3 at 25° C.

FIG. 12D is a photograph of a third replicate of a C70 black fabric after exposure to Composition 3 at 25° C.

FIG. 13A is a photograph of an untreated/unstained sample of C70 black fabric.

FIG. 13B is a photograph of a first replicate of a C70 black fabric after exposure to Composition 4 at 25° C.

FIG. 13C is a photograph of a second replicate of a C70 black fabric after exposure to Composition 4 at 25° C.

FIG. 13D is a photograph of a third replicate of a C70 black fabric after exposure to Composition 4 at 25° C.

FIG. 14A is a photograph of a first replicate, a second replicate, and a third replicate of a technical black cotton fabric after exposure to a zeolite having a dry particle size of 4 μm.

FIG. 14B is a photograph of a first replicate, a second replicate, and a third replicate of a technical black cotton fabric after exposure to precipitated calcium carbonate having a dry particle size of 7 μm.

FIG. 14C is a photograph of a first replicate, a second replicate, and a third replicate of a technical black cotton fabric after exposure to a magnesium carbonate (MgCO₃) having a dry particle size of 15 μm.

FIG. 14D is a photograph of a first replicate, a second replicate, and a third replicate of a technical black cotton fabric after exposure to microcrystalline cellulose having a dry particle size of 20 μm.

FIG. 14E is a photograph of a first replicate, a second replicate, and a third replicate of a technical black cotton fabric after exposure to a microcrystalline cellulose having a dry particle size of 50 μm.

FIG. 15A is a photograph of a first replicate, a second replicate, and a third replicate of a consumer black polyester fabric after exposure to a zeolite having a dry particle size of 4 μm.

FIG. 15B is a photograph of a first replicate, a second replicate, and a third replicate of a consumer black polyester fabric after exposure to precipitated calcium carbonate having a dry particle size of 7 μm.

FIG. 15C is a photograph of a first replicate, a second replicate, and a third replicate of a consumer black polyester fabric after exposure to a magnesium carbonate (MgCO₃) having a dry particle size of 15 μm.

FIG. 15D is a photograph of a first replicate, a second replicate, and a third replicate of a consumer black polyester fabric after exposure to microcrystalline cellulose having a dry particle size of 20 μm.

FIG. 15E is a photograph of a first replicate, a second replicate, and a third replicate of a consumer black polyester fabric after exposure to a microcrystalline cellulose having a dry particle size of 50 μm.

It should be understood that the various iterations are not limited to the examples illustrated in the figures.

### DETAILED DESCRIPTION

### Introduction and Definitions

This disclosure is written to describe the invention to a person having ordinary skill in the art, who will understand that this disclosure is not limited to the specific examples or iterations described. The examples and iterations are single instances of the invention which will make a much larger scope apparent to the person having ordinary skill in the art. Unless defined otherwise, all technical and scientific terms used herein have the same meaning as commonly understood by the person having ordinary skill in the art. It is also to be understood that the terminology used herein is for the purpose of describing examples and iterations only, and is not intended to be limiting, since the scope of the present disclosure will be limited only by the appended claims.

All the features disclosed in this specification (including any accompanying claims, abstract, and drawings) may be replaced by alternative features serving the same, equivalent, or similar purpose, unless expressly stated otherwise. Thus, unless expressly stated otherwise, each feature disclosed is one example only of a generic series of equivalent or similar features. The examples and iterations described herein are for illustrative purposes only and that various modifications or changes in light thereof will be suggested to the person having ordinary skill in the art and are to be included within the spirit and purview of this application. Many variations and modifications may be made to the iterations of the disclosure without departing substantially from the spirit and principles of the disclosure. All such modifications and variations are intended to be included herein within the scope of this disclosure. For example, unless otherwise indicated, the present disclosure is not limited to particular materials, reagents, reaction materials, manufacturing processes, or the like, as such can vary. It is also to be understood that the terminology used herein is for purposes of describing particular iterations only and is not intended to be limiting. It is also possible in the present disclosure that steps can be executed in different sequence where this is logically possible.

All numeric values are herein assumed to be modified by the term “about,” whether or not explicitly indicated. The term “about” generally refers to a range of numbers that one of skill in the art would consider equivalent to the recited value (for example, having the same function or result). In many instances, the term “about” may include numbers that are rounded to the nearest significant figure.

In everyday usage, indefinite articles (like “a” or “an”) precede countable nouns and noncountable nouns almost never take indefinite articles. It must be noted, therefore, that, as used in this specification and in the claims that follow, the singular forms “a,” “an,” and “the” include plural referents unless the context clearly dictates otherwise. Thus, for example, reference to “a support” includes a plurality of supports. Particularly when a single countable noun is listed as an element in a claim, this specification will generally use a phrase such as “a single.” For example, “a single support.”

Unless otherwise specified, all percentages indicating the amount of a component in a composition represent a percent by weight of the component based on the total weight of the composition.

Where a range of values is provided, it is understood that each intervening value, to the tenth of the unit of the lower limit (unless the context clearly dictates otherwise), between the upper and lower limit of that range, and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

In this specification and in the claims that follow, reference will be made to a number of terms that shall be defined to have the following meanings unless a contrary intention is apparent.

“Active Component” is the specific component(s) or chemical substance(s) within a formulation or product that is/are responsible for producing an intended functional effect.

Non-Active Component” refers to other components or substances present in a formulation or product that do not constitute the primary active component responsible for producing the intended functional effect.

“Particle size” may refer to the size of a single particle or to the size of a plurality of particles, such as, for example, a cluster of particles. The particle size of a spherical object can be unambiguously and quantitatively defined by its diameter. However, a typical material object is likely to be irregular in shape and non-spherical. There are several ways of extending the term “particle size” to apply to non-spherical particles. Existing definitions are based on replacing a given particle or cluster with an imaginary sphere that has one of the properties identical with the particle. Volume-based particle size equals the diameter of the sphere that has the same volume as a given particle. Area-based particle size equals the diameter of the sphere that has the same surface area as a given particle or cluster. Weight-based particle size equals the diameter of the sphere that has the same weight as a given particle or cluster. Hydrodynamic or aerodynamic particle size equals the diameter of the sphere that has the same drag coefficient as a given particle or cluster.

Pluralities of particles may have a particle size distribution. D50 and D100 are parameters commonly used in particle size distribution analysis to describe the median and maximum particle sizes, respectively. The D50 represents the particle size at which 50% of the cumulative mass of particles is smaller, while the D100 is the size below which 100% of the cumulative mass of particles is contained. The D50 serves as the midpoint of the particle size distribution, indicating the size in the middle of the distribution when particles are arranged in ascending order. In contrast, the D100 signifies the maximum size of particles in the distribution, where the cumulative distribution curve reaches 100%. The particles described herein may have a particle size distribution such that the D50 is from greater than about 150 micrometers to less than about 1700 micrometers.

“Dry particle size” of a material refers to the size of individual particles, aggregates, or agglomerates of the material when measured under conditions of low environmental relative humidity, specifically at an ambient temperature, where the environmental relative humidity is maintained at a level of less than 15%. This measurement is carried out to prevent or minimize any moisture-induced changes in the size, structure, or properties of the particles, ensuring that the size measurement accurately represents the material's characteristics in a low-humidity environment. The dry particle size may be determined using suitable techniques and instruments, such as laser diffraction, dynamic light scattering, or similar methods appropriate for the material under consideration. The dry particle size measurement provides valuable information for various applications, including but not limited to the pharmaceutical, chemical, and materials industries, where maintaining low humidity conditions is critical to preserve the material's integrity and performance.

“Average dry particle size” of a material is the mean size of individual particles, aggregates, or agglomerates of the material when measured under low environmental relative humidity (less than 15%) at ambient temperature, following the method defined for “dry particle size.” This measurement is crucial for various applications, including pharmaceuticals, chemicals, and materials, where maintaining low humidity conditions is essential for preserving material integrity and performance.

“Water-insoluble” refers to a substance or material that cannot be effectively dissolved or dispersed in water under ordinary conditions. When a material is labeled as “water-insoluble,” it implies that it exhibits limited or negligible solubility in water, and any attempt to dissolve it in water results in only minimal or no appreciable change in its physical state or chemical composition.

“At Least Partially Water-Insoluble” refers to a substance or material that, while not entirely insoluble in water, possesses limited or restricted solubility in water under ordinary conditions. Unlike materials that are completely water-insoluble, those described as “at least partially water-insoluble” may exhibit some degree of solubility or dispersion in water, but the extent of dissolution is minimal, and they generally do not readily dissolve or disperse in water.

“Swelling Index” is a numerical value representing the swelling capacity of a particle. It can be calculated by dividing the volume or weight of a swollen particle after immersion in water at a temperature of T (° C.) for a time t (sec) by the initial volume the dry particle. The swelling index is a dimensionless number.

$$Swelling Index = \frac{Volume of particle after exposure to water at T ( ° C . ) for t ( sec )}{Initial Volume of dry particle}$$

“Swelling index-adjusted particle size” is a quantitative measure that reflects the dimensions of a single particle or the average size of a group of particles when they have reached their maximum swelling capacity. This adjusted particle size is obtained by multiplying the particle size by the swelling index.

A “derivative of cellulose” is a compound or material that is chemically modified from cellulose, a natural polysaccharide found in plant cell walls. Cellulose derivatives may be created by altering the structure of cellulose through various chemical processes to impart specific properties or functionalities, such as improved solubility, increased flexibility, or enhanced compatibility with other materials. These modifications may result in a wide range of cellulose derivatives, and non-limiting examples include cellulose acetate, hydroxyethyl cellulose (HEC), methylcellulose, carboxymethyl cellulose (CMC), cellulose ethers (such as ethylcellulose, hydroxypropyl cellulose, and hydroxypropyl methylcellulose), and nitrocellulose.

“Crystalline Material” is a substance or solid structure characterized by the orderly and repeating arrangement of its constituent atoms, ions, or molecules in a three-dimensional lattice or framework. In a crystalline material, the atoms or particles are positioned with a high degree of periodicity, resulting in the formation of distinct, well-defined crystal structures. These materials exhibit specific and repeatable geometric patterns, known as crystal lattices, which give rise to the material's unique physical and chemical properties, including well-defined melting points, regular cleavage planes, and optical characteristics, such as birefringence. The opposite of a crystalline material is an amorphous material, which lacks a long-range order in its atomic arrangement. Crystalline materials can encompass a wide range of substances, including metals, minerals, and various organic and inorganic compounds.

“Water-soluble unit dose article,” “water-soluble fibrous structure”, and “water-soluble fibrous element” mean that the unit dose article, fibrous structure, and fibrous element are miscible in water. In other words, the unit dose article, fibrous structure, or fibrous element is capable of forming a homogeneous solution with water at ambient conditions.

“Ambient conditions” as used herein means 23° C.±1.0° C. and a relative humidity of 50%±2%. The water-soluble unit dose article may contain insoluble materials, which are dispersible in aqueous wash conditions to a suspension mean particle size that is less than about 20 microns, or less than about 50 microns.

### Unit Dose Articles

A unit dose article can comprise a water soluble substrate and a particulate material. The water soluble substrate may be for example, a fibrous substrate, a nonwoven substrate, or a combination thereof. An example of a nonwoven substrate can include a sheet. A nonwoven sheet can comprise a plurality of fibers. The fibers may be entangled to form a fibrous sheet.

Fibrous water-soluble unit dose articles, according to various iterations, may be dissolved under various wash conditions, e.g., low temperature, low water and/or short wash cycles or cycles where consumers have been overloading the machine, especially with items having high water absorption capacities, while providing sufficient delivery of active agents for the intended effect on the target consumer substrates (with similar performance as today's liquid products). Furthermore, the water-soluble unit dose articles described herein can be produced in an economical manner by spinning fibers comprising active agents. The water-soluble unit dose articles described herein also have improved cleaning performance.

### Laundry Detergent

Any of the formulations described herein, may also be delivered in the form of a laundry detergent formulation apart from the fibrous structure of the unit-dose articles.

### Fibrous Structure

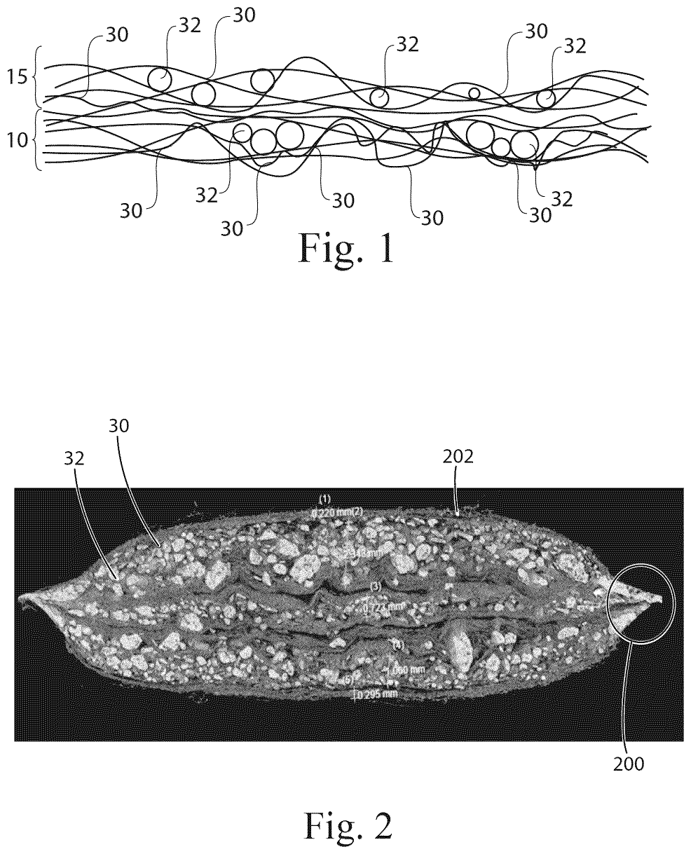

Fibrous structures comprise one or more fibrous elements. The fibrous elements can be associated with one another to form a structure. A fibrous structure can comprise one or more layers, the layers together forming a ply. A fibrous structure can also be shaped into a compartment, for example, a pouch. The fibrous water-soluble unit dose article can be viewed hierarchically starting from the form in which the consumer interacts with the water-soluble article and working backward to the raw materials from which the water-soluble article is made, e.g., plies, fibrous structures, and particles. The fibrous plies can be fibrous structures. For example, FIG. 1 shows a first ply 10 and a second ply 15 associated with the first ply 10, wherein the first ply 10 and the second ply 15 each comprises a plurality of fibrous elements 30, in this case filaments, and a plurality of particles 32. In the second ply 15, the particles 32 are dispersed randomly, in the x, y, and z axes, and in the first ply, the particles 32 are in pockets. FIG. 2 is a micro-CT scan image showing a cross-sectional view of an example of a water-soluble unit dose article comprising three plies, where each ply is formed of two layers, a fibrous element layer and a fibrous element/particle mixture layer. Each of the three plies comprises a plurality of fibrous elements 30, in this case filaments, and a plurality of particles 32. The multiply, multilayer article is sealed at the edges 200, so that the particles do not leak out. The outer surfaces of the article 202 are fibrous element layers.

The fibrous water-soluble unit dose article may comprise one or more plies. The fibrous water-soluble unit dose article may comprise at least two and/or at least three and/or at least four and/or at least five plies. The fibrous plies can be fibrous structures. Each ply may comprise one or more layers, for example one or more fibrous element layers, one or more particle layers, and/or one or more fibrous element/particle mixture layers. The layer(s) may be sealed. In particular, particle layers and fibrous element/particle mixture layers may be sealed, such that the particles do not leak out. The water-soluble unit dose articles may comprise multiple plies, where each ply comprises two layers, where one layer is a fibrous element layer and one layer is a fibrous element/particle mixture layer, and where the multiple plies are sealed (e.g., at the edges) together. Sealing may inhibit the leakage of particles as well as help the unit dose article maintain its original structure. However, upon addition of the water-soluble unit dose article to water, the unit dose article dissolves and releases the particles into the wash liquor.

The fibrous water-soluble unit dose articles may exhibit a thickness of greater than 0.01 mm and/or greater than 0.05 mm and/or greater than 0.1 mm and/or to about 100 mm and/or to about 50 mm and/or to about 20 mm and/or to about 10 mm and/or to about 5 mm and/or to about 2 mm and/or to about 0.5 mm and/or to about 0.3 mm as measured by the Thickness Test Method described herein.

The fibrous water-soluble unit dose articles may have basis weights of from about 500 grams/m² to about 5,000 grams/m², or from about 1,000 grams/m² to about 4,000 grams/m², or from about 1,500 grams/m² to about 3,500 grams/m², or from about 2,000 grams/m² to about 3,000 grams/m², as measured according to the Basis Weight Test Method described herein. In addition the nonwoven sheet and/or fibrous structure may have a basis weight of about 20 grams/m² to about 60 grams/m², preferably about 20 grams/m² to about 55 grams/m², more preferably about 25 grams/m² to about 50 grams/m², most preferably about 25 grams/m² to about 45 grams/m²

### Method for Making

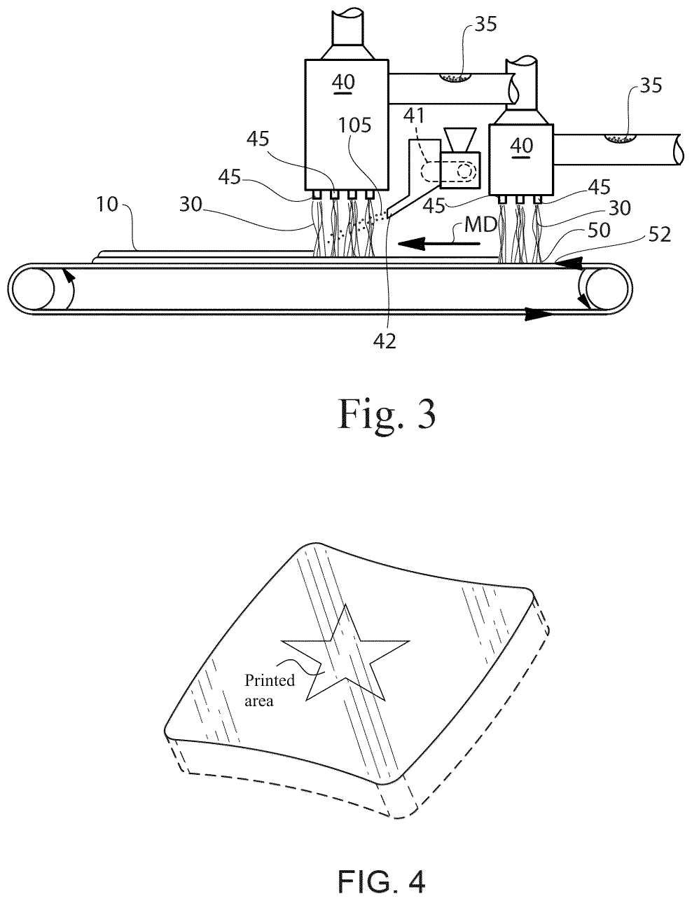

As exemplified by illustration in FIG. 3, a solution of a filament forming composition 35 is provided. The filament forming composition can comprise one or more filament forming materials and optionally one or more active agents. The filament forming composition 35 is passed through one or more die block assemblies 40 comprising a plurality of spinnerets 45 to form a plurality of fibrous elements 30 comprising the one or more filament forming materials and optionally one or more active agents. Multiple die block assemblies 40 can be employed to spin different layers of fibrous elements 30, with the fibrous elements 30 of different layers having a composition that differ from one another or are the same as one another. More than two die block assemblies in series can be provided to form three, four, or any other integer number of layers in a given ply. The fibrous elements 30 can be deposited on a belt 50 moving in a machine direction MD to form a first ply 10.

Particles can be introduced into the stream of the fibrous elements 30 between the die block assembly 40 and the belt 50. Particles can be fed from a particle receiver onto a belt feeder 41 or optionally a screw feeder. The belt feeder 41 can be set and controlled to deliver the desired mass of particles into the process. The belt feeder can feed an air knife 42 that suspends and directs the particles in an air stream into the fibrous elements 30 to form a particle-fiber layer of comingled fibrous elements 30 and particles that is subsequently deposited on the belt 50.

To form the water-soluble product, a first ply 10 can be provided. A second ply 15 can be provided separate from the first ply 10. The first ply 10 and the second ply 15 are superposed with one another. By superposed it is meant that one is positioned above or below the other with the proviso that additional plies or other materials, for example active agents, may be positioned between the superposed plies. A portion of the first ply 10 can be joined to a portion of the second ply 15 to form the water-soluble product 5. Each ply may comprise one or more layers.

### Printed Area

As shown in FIG. 4, the surface of a fibrous water-soluble unit dose articles may comprise a printed area. The printed area may cover between about 10% and about 100% of the surface of the article. The area of print may comprise inks, pigments, dyes, bluing agents or mixtures thereof. The area of print may be opaque, translucent or transparent. The area of print may comprise a single color or multiple colors. The printed area maybe on more than one side of the article and contain instructional text and/or graphics. The surface of the water-soluble unit dose article may comprise an aversive agent, for example a bittering agent. Suitable bittering agents include, but are not limited to, naringin, sucrose octacetate, quinine hydrochloride, denatonium benzoate, or mixtures thereof. Any suitable level of aversive agent may be used. Suitable levels include, but are not limited to, 1 to 5000 ppm, or even 100 to 2500 ppm, or even 250 to 2000 ppm.

### Fibrous Elements

The fibrous elements may be water-soluble. The fibrous elements may comprise one or more filament-forming materials and/or one or more active agents, such as a surfactant. The one or more active agents may be releasable from the fibrous element, such as when the fibrous element and/or fibrous structure comprising the fibrous element is exposed to conditions of intended use.

The fibrous elements of the present invention may be spun from a filament-forming composition, also referred to as fibrous element-forming compositions, via suitable spinning process operations, such as meltblowing, spunbonding, electro-spinning, and/or rotary spinning.

“Filament-forming composition” and/or “fibrous element-forming composition” as used herein means a composition that is suitable for making a fibrous element of the present invention such as by meltblowing and/or spunbonding. The filament-forming composition comprises one or more filament-forming materials that exhibit properties that make them suitable for spinning into a fibrous element. The filament-forming material may comprise a polymer. In addition to one or more filament-forming materials, the filament-forming composition may comprise one or more active agents, for example, a surfactant. In addition, the filament-forming composition may comprise one or more polar solvents, such as water, into which one or more, for example all, of the filament-forming materials and/or one or more, for example all, of the active agents are dissolved and/or dispersed prior to spinning a fibrous element, such as a filament from the filament-forming composition.

The filament-forming composition may comprise two or more different filament-forming materials. Thus, the fibrous elements may be monocomponent (one type of filament-forming material) and/or multicomponent, such as bicomponent. The two or more different filament-forming materials may be randomly combined to form a fibrous element. The two or more different filament-forming materials may be orderly combined to form a fibrous element, such as a core and sheath bicomponent fibrous element, which is not considered a random mixture of different filament-forming materials for purposes of the present disclosure. Bicomponent fibrous elements may be in any form, such as side-by-side, core and sheath, islands-in-the-sea and the like.

The fibrous elements may be substantially free of alkylalkoxylated sulfate. Each fibrous element may comprise from about 0%, or from about 0.1%, or from about 5%, or from about 10%, or from about 15%, or from about 20%, or from about 25%, or from about 30%, or from about 35%, or from about 40% to about 0.2%, or to about 1%, or to about 5%, or to about 10 or to about 15%, or to about 20%, or to about 25%, or to about 30%, or to about 35% or to about 40%, or to about 50% by weight on a dry fibrous element basis of an alkylalkoxylated sulfate. The amount of alkylalkoxylated sulfate in each of the fibrous elements is sufficiently small so as not to affect the processing stability and film dissolution thereof. Alkylakoxylated sulfates, when dissolved in water, may undergo a highly viscous hexagonal phase at certain concentration ranges, e.g., 30-60% by weight, resulting in a gel-like substance. Therefore, if incorporated into the fibrous elements in a significant amount, alkylalkoxylated sulfates may significantly slow down the dissolution of the water-soluble unit dose articles in water, and worse yet, result in undissolved solids afterwards. Correspondingly, most of such surfactants are formulated into the particles.

The fibrous elements may each contain at least one filament-forming material and an active agent, preferably a surfactant. The surfactant may have a relatively low hydrophilicity, as such a surfactant is less likely to form a viscous, gel-like hexagonal phase when being diluted. By using such a surfactant in forming the filaments, gel-formation during wash may be effectively reduced, which in turn may result in faster dissolution and low or no residues in the wash. The surfactant can be selected, for example, from the group consisting of unalkoxylated C6-C20 linear or branched alkyl sulfates (AS), C6-C20 linear alkylbenzene sulfonates (LAS), and combinations thereof. The surfactant may be a C6-C20 linear alkylbenzene sulfonates (LAS). LAS surfactants are well known in the art and can be readily obtained by sulfonating commercially available linear alkylbenzenes. Exemplary C₆-C₂₀ linear alkylbenzene sulfonates that can be used include alkali metal, alkaline earth metal or ammonium salts of C₆-C₂₀ linear alkylbenzene sulfonic acids, such as the sodium, potassium, magnesium and/or ammonium salts of C₁₁-C₁₈ or C₁₁-C₁₄ linear alkylbenzene sulfonic acids. The sodium or potassium salts of C₁₂ linear alkylbenzene sulfonic acids, for example, the sodium salt of C₁₂ linear alkylbenzene sulfonic acid, i.e., sodium dodecylbenzene sulfonate, may be used as the first surfactant.

The fibrous element may comprise at least about 5%, and/or at least about 10%, and/or at least about 15%, and/or at least about 20%, and/or less than about 80%, and/or less than about 75%, and/or less than about 65%, and/or less than about 60%, and/or less than about 55%, and/or less than about 50%, and/or less than about 45%, and/or less than about 40%, and/or less than about 35%, and/or less than about 30%, and/or less than about 25% by weight on a dry fibrous element basis and/or dry fibrous structure basis of the filament-forming material and greater than about 20%, and/or at least about 35%, and/or at least about 40%, and/or at least about 45%, and/or at least about 50%, and/or at least about 55%, and/or at least about 60%, and/or at least about 65%, and/or at least about 70%, and/or less than about 95%, and/or less than about 90%, and/or less than about 85%, and/or less than about 80%, and/or less than about 75% by weight on a dry fibrous element basis and/or dry fibrous structure basis of an active agent, preferably surfactant. The fibrous element may comprise greater than about 80% by weight on a dry fibrous element basis and/or dry fibrous structure basis of surfactant.

Preferably, each fibrous element may be characterized by a sufficiently high total surfactant content, e.g., at least about 30%, or at least about 40%, or at least about 50%, or at least about 60%, or at least about 70%, by weight on a dry fibrous element basis and/or dry fibrous structure basis of the first surfactant.

The total level of filament-forming materials present in the fibrous element may be from about 5% to less than about 80% by weight on a dry fibrous element basis and/or dry fibrous structure basis and the total level of surfactant present in the fibrous element may be greater than about 20% to about 95% by weight on a dry fibrous element basis and/or dry fibrous structure basis.

One or more of the fibrous elements may comprise at least one additional surfactant selected from the group consisting of other anionic surfactants (i.e., other than AS and LAS), nonionic surfactants, zwitterionic surfactants, amphoteric surfactants, cationic surfactants, and combinations thereof.

Other suitable anionic surfactants include C₆-C₂₀ linear or branched alkyl sulfonates, C₆-C₂₀ linear or branched alkyl carboxylates, C₆-C₂₀ linear or branched alkyl phosphates, C₆-C₂₀ linear or branched alkyl phosphonates, C₆-C₂₀ alkyl N-methyl glucose amides, C₆-C₂₀ methyl ester sulfonates (MES), and combinations thereof.

Suitable nonionic surfactants include alkoxylated fatty alcohols. The nonionic surfactant may be selected from ethoxylated alcohols and ethoxylated alkyl phenols of the formula R(OC₂H₄)ₙOH, wherein R is selected from the group consisting of aliphatic hydrocarbon radicals containing from about 8 to about 15 carbon atoms and alkyl phenyl radicals in which the alkyl groups contain from about 8 to about 12 carbon atoms, and the average value of n is from about 5 to about 15. Non-limiting examples of nonionic surfactants useful herein include: C₈-C₁₈ alkylethoxylates, such as, NEODOL® nonionic surfactants from Shell; C₆-C₁₂ alkyl phenol alkoxylates where the alkoxylate units may be ethyleneoxy units, propyleneoxy units, or a mixture thereof; C₁₂-C₁₈ alcohol and C₆-C₁₂ alkyl phenol condensates with ethylene oxide/propylene oxide block polymers such as Pluronic® from BASF; C₁₄-C₂₂ mid-chain branched alcohols, BA; C₁₄-C₂₂ mid-chain branched alkylalkoxylates, BAEₓ, wherein x is from 1 to 30; alkylpolysaccharides; specifically alkylpolyglycosides; polyhydroxy fatty acid amides; and ether capped poly(oxyalkylated) alcohol surfactants. Suitable nonionic detersive surfactants also include alkyl polyglucoside and alkylalkoxylated alcohol. Suitable nonionic surfactants also include those sold under the tradename Lutensol® from BASF.

Non-limiting examples of cationic surfactants include: the quaternary ammonium surfactants, which can have up to 26 carbon atoms include: alkoxylate quaternary ammonium (AQA) surfactants; dimethyl hydroxyethyl quaternary ammonium; dimethyl hydroxyethyl lauryl ammonium chloride; polyamine cationic surfactants; cationic ester surfactants; and amino surfactants, e.g., amido propyldimethyl amine (APA). Suitable cationic detersive surfactants also include alkyl pyridinium compounds, alkyl quaternary ammonium compounds, alkyl quaternary phosphonium compounds, alkyl ternary sulphonium compounds, and mixtures thereof.

Suitable cationic detersive surfactants are quaternary ammonium compounds having the general formula:

(R)(R₁)(R₂)(R₃)N⁺X⁻

wherein, R is a linear or branched, substituted or unsubstituted C₆₋₁₈ alkyl or alkenyl moiety, R₁ and R₂ are independently selected from methyl or ethyl moieties, R₃ is a hydroxyl, hydroxymethyl or a hydroxyethyl moiety, X is an anion which provides charge neutrality, suitable anions include: halides, for example chloride; sulphate; and sulphonate. Suitable cationic detersive surfactants are mono-C₆₋₁₈ alkyl mono-hydroxyethyl di-methyl quaternary ammonium chlorides. Highly suitable cationic detersive surfactants are mono-C₈₋₁₀ alkyl mono-hydroxyethyl di-methyl quaternary ammonium chloride, mono-C₁₀₋₁₂ alkyl mono-hydroxyethyl di-methyl quaternary ammonium chloride and mono-C₁₀ alkyl mono-hydroxyethyl di-methyl quaternary ammonium chloride.

Suitable examples of zwitterionic surfactants include: derivatives of secondary and tertiary amines, including derivatives of heterocyclic secondary and tertiary amines; derivatives of quaternary ammonium, quaternary phosphonium or tertiary sulfonium compounds; betaines, including alkyl dimethyl betaine, cocodimethyl amidopropyl betaine, and sulfo and hydroxy betaines; C₈ to C₁₈ (e.g., from C₁₂ to C₁₈) amine oxides; N-alkyl-N,N-dimethylammino-1-propane sulfonate, where the alkyl group can be C₈ to C₁₈.

Suitable amphoteric surfactants include aliphatic derivatives of secondary or tertiary amines, or aliphatic derivatives of heterocyclic secondary and tertiary amines in which the aliphatic radical may be straight or branched-chain and where one of the aliphatic substituents contains at least about 8 carbon atoms, or from about 8 to about 18 carbon atoms, and at least one of the aliphatic substituents contains an anionic water-solubilizing group, e.g. carboxy, sulfonate, sulfate. Suitable amphoteric surfactants also include sarcosinates, glycinates, taurinates, and mixtures thereof.

The fibrous elements may comprise a surfactant system containing only anionic surfactants, e.g., either a single anionic surfactant or a combination of two or more different anionic surfactants. Alternatively, the fibrous elements may include a composite surfactant system, e.g., containing a combination of one or more anionic surfactants with one or more nonionic surfactants, or a combination of one or more anionic surfactants with one or more zwitterionic surfactants, or a combination of one or more anionic surfactants with one or more amphoteric surfactants, or a combination of one or more anionic surfactants with one or more cationic surfactants, or a combination of all the above-mentioned types of surfactants (i.e., anionic, nonionic, amphoteric and cationic).

In general, fibrous elements are elongated having a length greatly exceeding average diameter, e.g., a length to average diameter ratio of at least about 10. A fibrous element may be a filament or a fiber. Filaments are relatively longer than fibers. A filament may have a length of greater than or equal to about 5.08 cm (2 in.), and/or greater than or equal to about 7.62 cm (3 in.), and/or greater than or equal to about 10.16 cm (4 in.), and/or greater than or equal to about 15.24 cm (6 in.). A fiber may have a length of less than about 5.08 cm (2 in.), and/or less than about 3.81 cm (1.5 in.), and/or less than about 2.54 cm (1 in.). In addition, each fiber may have a width of about 100 μm or less, about 75 μm or less, about 50 μm or less, about 25 μm or less, about 10 μm or less, about 5 μm or less, about 1 μm or less. or a mixture thereof. Those skilled in the art will be aware of standard methods and techniques to measure the width. Preferred methods include Scanning Electron Microscope (SEM) or an Optical Microscope together with image analysis software.

The one or more filament-forming materials and active agents may be present in the fibrous element at a weight ratio of total level of filament-forming materials to active agents of about 2.0 or less, and/or about 1.85 or less, and/or less than about 1.7, and/or less than about 1.6, and/or less than about 1.5, and/or less than about 1.3, and/or less than about 1.2, and/or less than about 1, and/or less than about 0.7, and/or less than about 0.5, and/or less than about 0.4, and/or less than about 0.3, and/or greater than about 0.1, and/or greater than about 0.15, and/or greater than about 0.2. The one or more filament-forming materials and active agents may be present in the fibrous element at a weight ratio of total level of filament-forming materials to active agents of about 0.2 to about 0.7.

The fibrous element may comprise from about 10% to less than about 80% by weight on a dry fibrous element basis and/or dry fibrous structure basis of a filament-forming material, such as polyvinyl alcohol polymer, starch polymer, and/or carboxymethylcellulose polymer, and greater than about 20% to about 90% by weight on a dry fibrous element basis and/or dry fibrous structure basis of an active agent, such as surfactant. The fibrous element may further comprise a plasticizer, such as glycerin, and/or pH adjusting agents, such as citric acid. The fibrous element may have a weight ratio of filament-forming material to active agent of about 2.0 or less. The filament-forming material may be selected from the group consisting of polyvinyl alcohol, starch, carboxymethylcellulose, polyethylene oxide, and other suitable polymers, especially hydroxyl-containing polymers and their derivatives. The filament-forming material may range in weight average molecular weight from about 100,000 g/mol to about 3,000,000 g/mol. It is believed that in this range, the filament-forming material may provide extensional rheology, without being so elastic that fiber attenuation is inhibited in the fiber-making process.

Preferably, the filament-forming material comprises polyvinyl alcohol. Preferably, the polyvinyl alcohol polymer is a polyvinyl alcohol homopolymer. Preferably, the polyvinyl alcohol homopolymer has an average percentage degree of hydrolysis of from 75% to 100%, preferably of from 80% to 95%, most preferably of from 85% to 90%. Preferably, the polyvinyl alcohol homopolymer has an average viscosity of from about 1 to about 30 mPas, preferably from about 5 to about 25 mPas, most preferably from about 10 to about 20 mPas, wherein the viscosity is measured as a 4% aqueous solution in demineralized water at 20° C.

The fibers preferably comprise from about 0.1% to about 15% by weight of the fibers of a gel-breaker, wherein the gel-breaker comprises a polyol, sugar alcohol, amine, amide, carbohydrate, multivalent cation, or a mixture thereof, preferably polyols, sugar alcohols, or a mixture thereof. Preferably, the fibers comprise about 1% to about 12%, preferably about 2% to about 10% by weight of the fibers of the gel-breaker.

The one or more active agents may be releasable and/or released when the fibrous element and/or fibrous structure comprising the fibrous element is exposed to conditions of intended use. The one or more active agents in the fibrous element may be selected from the group consisting of surfactants, organic polymeric compounds, and mixtures thereof.

The fibrous elements may exhibit a diameter of less than about 300 μm, and/or less than about 75 μm, and/or less than about 50 μm, and/or less than about 25 μm, and/or less than about 10 μm, and/or less than about 5 μm, and/or less than about 1 μm as measured according to the Diameter Test Method described herein. The fibrous elements may exhibit a diameter of greater than about 1 μm as measured according to the Diameter Test Method described herein. The diameter of a fibrous element may be used to control the rate of release of one or more active agents present in the fibrous element and/or the rate of loss and/or altering of the fibrous element's physical structure.

The fibrous element may comprise two or more different active agents, which are compatible or incompatible with one another. The fibrous element may comprise an active agent within the fibrous element and an active agent on an external surface of the fibrous element, such as an active agent coating on the fibrous element. The active agent on the external surface of the fibrous element may be the same or different from the active agent present in the fibrous element. If different, the active agents may be compatible or incompatible with one another. The one or more active agents may be uniformly distributed or substantially uniformly distributed throughout the fibrous element. The one or more active agents may be distributed as discrete regions within the fibrous element.

### Particulate Material

The unit dose articles may comprise a particulate material. A particulate material can comprise one or more at least partially water insoluble particles which comprises a first component, preferably an active component, and a second component, preferably a non-active component. The particulate material may reside between plies of the water-soluble fibrous structure. Similarly, the laundry detergents described herein may comprise a variety of active and inactive agents. It has been unexpectedly discovered that some active agents may include non-active components, which may greatly contribute to residue seen on fabrics after washing. This disclosure focuses on a particulate material that may be layered between plies of the fibrous structure.

Particles or clusters of particles may be distributed in pockets distributed in the layer, where such pockets may be formed between layers of fibrous elements; the contact network and porosity within each cluster of particles is governed by physics of conventional particle packing, yet the clusters are substantially dilated in the layer. The particles or clusters of particles may be distributed relatively homogeneously throughout the fibrous structure, substantially free of local particle clusters; packing is substantially dilated on the scale of individual particles, with fewer inter-particle contacts and greater inter-particle porosity. Without wishing to be bound by theory, it is believed that a water-soluble unit dose article comprising a layer comprising fibrous elements and particles, where sticky surfactants, such as AES, are segregated into particles having a dilated structure, provides for an improvement in dispersion and dissolution of the unit dose article, both by faster imbibition of water into the dilated structure and by a reduction in contacts among particles having sticky surfactants.

The particulate material may comprise at least one particle which is at least partially water insoluble. Each particle may comprise a first component, preferably an active component, and a second component, preferably a non-active component. These second components, preferably non-active components, may be insoluble or partially soluble. The non-active components may be selected from a filler, a carrier, a structurant, a builder, a cellulosic polymer, and mixtures thereof.

The active components be selected from a surfactant, an organic polymeric compound, an enzyme, an enzyme stabilizer, a bleach system, a brightener, a hueing agent, a chelating agent, a suds suppressor, a conditioning agent, a humectant, a perfume, a perfume microcapsule, an alkalinity system, a pH control system, a buffer, an alkanolamine, and mixtures thereof.

The particles or clusters of particles may have a particle size distribution such that the D100 is in a range of from about 1300 μm to about 20 μm, or about 1200 μm to about 50 μm, or about 1100 μm to about 100 μm, or about 1000 μm to about 200 μm, or about 900 μm to about 300 μm, or about 800 μm to about 400 μm, or about 700 μm to about 500 μm.

The particles or clusters of particles may have a particle size distribution such that the D50 is in a range of from about 1800 μm to about 25 μm, or about 1700 μm to about 50 μm, or about 1600 μm to about 100 μm, or about 1500 μm to about 200 μm, or about 1400 μm to about 300 μm, or about 1300 μm to about 400 μm, or about 1200 μm to about 500 μm, or about 1100 μm to about 600 μm, or about 1000 μm to about 700 μm, or about 900 μm to about 800 μm.

### Non-Active Components

As previously expressed, non-active components are components or substances present in a formulation or product that do not constitute the primary active component responsible for producing the intended functional effect. Non-active components may server a variety of other functions and may be generally classified according to those other functions. It is to be appreciated, however, that non-active components may server more than one function and that some overlap is to be expected. Therefore, the following categories should not be construed overly rigidly; many of the examples given for each category may be reasonably classified into other categories. An attempt has been made, however, to categorize the examples of many non-active components by the primary function as a filler, a carrier, a structurant, or a builder.

### Filler

Generally, a filler is a non-active component that primarily serves to enhance the bulk and volume of the detergent formulation. Fillers, such as soluble salts (e.g., sodium sulfate, sodium chloride, sodium carbonate), contribute to the physical structure of the detergent product without actively participating in the cleaning process. They are employed to optimize the product's form and economic efficiency. These fillers serve a primarily structural or economic purpose, contributing to the overall physical integrity of the detergent product and facilitating cost-effective manufacturing. While fillers do not actively participate in the cleaning process, they play a crucial role in optimizing the detergent's physical characteristics, such as its appearance, texture, and handling properties. Sodium sulfate, sodium chloride, and sodium carbonate may be employed as fillers due to their solubility in water and compatibility with detergent formulations. It is to be appreciated that other examples of suitable fillers may be identified and employed based on these criteria.

### Carrier

A carrier may serve as a medium for the even distribution and dispersion of active components, facilitating their effective delivery during use. A carrier may aid in optimizing the solubility and dispersibility of cleaning agents in the wash. Examples of carriers include inorganic salts, clays, starches, cyclodextrins, as well as derivatives thereof and/or combinations thereof. Examples of inorganic salts include but are not limited to magnesium carbonate, calcium carbonate, potassium carbonate, derivatives thereof, and/or combinations thereof. Examples of clays include but are not limited to kaolin, bentonite, montmorillonite, illite, derivatives thereof, and/or combinations thereof. Examples of cyclodextrans include but are not limited to alpha-cyclodextrin, beta-cyclodextrin, and gamma-cyclodextrin, derivatives thereof, and/or combinations thereof.

### Structurant

A structuring agent or a structurant is a component that imparts a specific physical structure or form to the solid laundry detergent. It contributes to the overall stability and coherence of the product. Structuring agents play a role in shaping the detergent into a desired form, such as tablets or bars, and help maintain its structural integrity during storage and use. While fillers may also contribute to structure, structuring agents specifically focus on shaping the detergent product.

Examples of structurants include silicates, including but not limited to sodium silicates. A structurant may comprise one or more suitable cellulosic polymers and/or their derivates including those selected from microcrystalline cellulose, alkyl cellulose, alkyl alkoxyalkyl cellulose, carboxyalkyl cellulose, alkyl carboxyalkyl cellulose. The cellulosic polymers may be selected from the group consisting of carboxymethyl cellulose, methyl cellulose, methyl hydroxyethyl cellulose, methyl carboxymethyl cellulose, and mixtures thereof. In one aspect, the carboxymethyl cellulose has a degree of carboxymethyl substitution from 0.5 to 0.9 and a molecular weight from about 20,000 Da to about 300,000 Da, or about 30,000 Da to about 290,000 Da, or about 40,000 Da to about 280,000 Da, or about 50,000 Da to about 270,000 Da, or about 60,000 Da to about 260,000 Da, or about 70,000 Da to about 250,000 Da, or about 80,000 Da to about 240,000 Da, or about 90,000 Da to about 230,000 Da, or about 100,000 Da to about 220,000 Da, or about 110,000 Da to about 210,000 Da, or about 100,000 Da to about 200,000 Da, or about 110,000 Da to about 190,000 Da, or about 120,000 Da to about 180,000 Da, or about 140,000 Da to about 170,000 Da, or about 130,000 Da to about 160,000 Da, or about 140,000 Da to about 150,000 Da.

### Builders

Builders are components in a formulation that primarily contribute to water softening, ion exchange, or complexation reactions, enhancing the overall cleaning efficiency of the product. They are not the primary active agents responsible for the intended functional effect of the detergent, which is typically the cleaning action.

Suitable builders include aluminosilicates (e.g., zeolite builders, such as zeolite A, zeolite P, and zeolite MAP), silicates, phosphates, such as polyphosphates (e.g., sodium tri-polyphosphate), especially sodium salts thereof; carbonates, bicarbonates, sesquicarbonates, and carbonate minerals other than sodium carbonate or sesquicarbonate; organic mono-, di-, tri-, and tetracarboxylates, especially water-soluble nonsurfactant carboxylates in acid, sodium, potassium or alkanolammonium salt form, as well as oligomeric or water-soluble low molecular weight polymer carboxylates including aliphatic and aromatic types; and phytic acid. Additional suitable builders may be selected from citric acid, lactic acid, fatty acid, polycarboxylate builders, for example, copolymers of acrylic acid, copolymers of acrylic acid and maleic acid, and copolymers of acrylic acid and/or maleic acid, and other suitable ethylenic monomers with various types of additional functionalities. Alternatively, the composition may be substantially free of builder.

### Active Components

As previously expressed, active components are key components or substances present in a formulation or product that constitute the primary agents responsible for producing the intended functional effect. Active components play diverse roles and can be broadly classified according to their distinct functions. It is important to acknowledge that active components may serve more than one function, and some overlap is to be anticipated. Therefore, the subsequent categories should not be construed overly rigidly; many of the examples given for each category may be reasonably classified into other categories. An attempt has been made, however, to categorize the examples of many active components by their primary function. The following list outlines types of active components, including surfactants, enzymes, polymeric dispersing agents, soil release polymers, amines, bleaching agents, bleach catalysts, brightness agents, fabric softening agents, encapsulates, perfumes, dye transfer inhibiting agents, chelating agents, suds suppressors, suds boosters, conditioning agents, fabric enhancement agents, pearlescent agents, hygiene and malodor agents, and buffer systems. Each active component contributes uniquely to the overall efficacy and performance of the formulation, working collectively to achieve the intended functional effects in the end product.

### Surfactant

The surfactant may be selected from the group consisting of anionic surfactants, nonionic surfactants, cationic surfactants, zwitterionic surfactants, amphoteric surfactants, ampholytic surfactants, and mixtures thereof. These surfactants are described in more detail above.

### Enzymes

Examples of suitable enzymes include, but are not limited to, metalloproteases, hemicellulases, peroxidases, proteases, cellulases, xylanases, lipases, phospholipases, esterases, cutinases, pectinases, mannanases, pectate lyases, keratinases, reductases, oxidases, phenoloxidases, lipoxygenases, ligninases, pullulanases, tannases, pentosanases, malanases, β-glucanases, arabinosidases, hyaluronidase, chondroitinase, laccase, and amylases, or mixtures thereof. A typical combination is an enzyme cocktail that may comprise, for example, a protease and lipase in conjunction with amylase. When present in a detergent composition, the aforementioned additional enzymes may be present at levels from about 0.00001% to about 2%, from about 0.0001% to about 1% or even from about 0.001% to about 0.5% enzyme protein by weight of the composition. The compositions disclosed herein may comprise from about 0.001% to about 1% by weight of an enzyme (as an adjunct), which may be selected from the group consisting of lipase, amylase, protease, mannanase, cellulase, pectinase, and mixtures thereof.

### Polymeric Dispersing Agents

Suitable polymers include, but are not limited to, polymeric carboxylates, such as polyacrylates, poly acrylic-maleic co-polymers, and sulfonated modifications thereof, for example, a hydrophobically modified sulfonated acrylic acid copolymer. The polymer may be a cellulosic based polymer, a polyester, a polyterephthalate, a polyethylene glycol, an ethylene oxide-propylene oxide-ethylene oxide (EOx₁POyEOx₂) triblock copolymer, where each of x₁ and x₂ is in the range of about 2 to about 140 and y is in the range of from about 15 to about 70, a polyethyleneimine, any modified variant thereof, such as polyethylene glycol having grafted vinyl and/or alcohol moieties, and any combination thereof. In some cases, the dispersant polymer may also function as a rheology modifier, as described above.

Suitable polyethyleneimine polymers include propoxylated polyalkylenimine (e.g., PEI) polymers. The propoxylated polyalkylenimine (e.g., PEI) polymers may also be ethoxylated. The propoxylated polyalkylenimine (e.g., PEI) polymers may have inner polyethylene oxide blocks and outer polypropylene oxide blocks, the degree of ethoxylation and the degree of propoxylation not going above or below specific limiting values. The ratio of polyethylene blocks to polypropylene blocks (n/p) may be from about 0.6, or from about 0.8, or from about 1, to a maximum of about 10, or a maximum of about 5, or a maximum of about 3. The n/p ratio may be about 2. The propoxylated polyalkylenimines may have PEI backbones having weight average molecular weights (as determined prior to alkoxylation) of from about 200 g/mol to about 1200 g/mol, or from about 400 g/mol to about 800 g/mol, or about 600 g/mol. The molecular weight of the propoxylated polyalkylenimines may be from about 8,000 to about 20,000 g/mol, or from about 10,000 to about 15,000 g/mol, or about 12,000 g/mol.

Suitable propoxylated polyalkylenimine polymers may include compounds of the following structure:

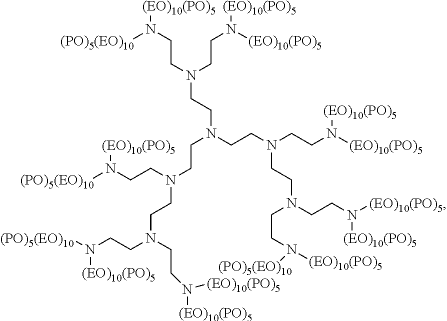

where EOs are ethoxylate groups and POs are propoxylate groups. The compound shown above is a PEI where the molar ratio of EO:PO is 10:5 (e.g., 2:1). Other similar, suitable compounds may include EO and PO groups present in a molar ratio of about 10:5 or about 24:16.

### Soil Release Polymer

Suitable soil release polymers have a structure as defined by one of the following structures (I), (II) or (III):

−[(OCHR¹CHR²)ₐ—O—OC—Ar—CO—]_{d} (I)

—[(OCHR³—CHR⁴)_{b}—O—OC—sAr—CO—]ₑ (II)

—[(OCHR⁵—CHR⁶)_{c}—OR⁷]_{f} (III)

wherein:
a, b and c are from 1 to 200;
d, e and f are from 1 to 50;
Ar is a 1,4-substituted phenylene;
sAr is 1,3-substituted phenylene substituted in position 5 with SO₃Me; Me is Li, K, Mg/2, Ca/2, Al/3, ammonium, mono-, di-, tri-, or tetraalkylammonium wherein the alkyl groups are C₁-C₁₈ alkyl or C₂-C₁₀ hydroxyalkyl, or mixtures thereof;
R¹, R², R³, R⁴, R⁵ and R⁶ are independently selected from H or C₁-C₁₅ n- or iso-alkyl; and R⁷ is a linear or branched C₁-C₁₅ alkyl, or a linear or branched C₂-C₃₀ alkenyl, or a cycloalkyl group with 5 to 9 carbon atoms, or a C₈-C₃₀ aryl group, or a C₆-C₃₀ arylalkyl group.

Suitable soil release polymers are polyester soil release polymers such as Repel-o-tex polymers, including Repel-o-tex SF, SF-2 and SRP6 supplied by Rhodia. Other suitable soil release polymers include Texcare polymers, including Texcare SRA100, SRA300, SRN100, SRN170, SRN240, SRN300 and SRN325 supplied by Clariant. Other suitable soil release polymers are Marloquest polymers, such as Marloquest SL supplied by Sasol.

### Amines

Non-limiting examples of amines may include, but are not limited to, polyetheramines, polyamines, oligoamines, triamines, diamines, pentamines, tetraamines, or combinations thereof. Specific examples of suitable additional amines include tetraethylenepentamine, triethylenetetraamine, diethylenetriamine, or a mixture thereof.

### Bleaching Agents

Suitable bleaching agents other than bleaching catalysts include 2,2′,thiophene-2,5-diylbis(benzoxazole), photobleaches, bleach activators, hydrogen peroxide, sources of hydrogen peroxide, pre-formed peracids and mixtures thereof. In general, when a bleaching agent is used, the detergent compositions of the present invention may comprise from about 0.1% to about 50% or even from about 0.1% to about 25% bleaching agent by weight of the detergent composition.

### Bleach Catalysts

Suitable bleach catalysts include, but are not limited to: iminium cations and polyions; iminium zwitterions; modified amines; modified amine oxides; N-sulphonyl imines; N-phosphonyl imines; N-acyl imines; thiadiazole dioxides; perfluoroimines; cyclic sugar ketones and mixtures thereof.

### Brighteners

Commercial fluorescent brighteners suitable for the present disclosure can be classified into subgroups, including but not limited to: derivatives of stilbene, pyrazoline, coumarin, benzoxazoles, carboxylic acid, methinecyanines, dibenzothiophene-5,5-dioxide, azoles, 5- and 6-membered-ring heterocycles, and other miscellaneous agents.

The fluorescent brightener may be selected from the group consisting of disodium 4,4′-bis{[4-anilino-6-morpholino-s-triazin-2-yl]-amino}-2,2′-stilbenedisulfonate (brightener 15, commercially available under the tradename Tinopal AMS-GX by BASF), disodium4,4′-bis{[4-anilino-6-(N-2-bis-hydroxyethyl)-s-triazine-2-yl]-amino}-2,2′-stilbenedisulonate (commercially available under the tradename Tinopal UNPA-GX by BASF), disodium 4,4′-bis{[4-anilino-6-(N-2-hydroxyethyl-N-methylamino)-s-triazine-2-yl]-amino}-2,2′-stilbenedisulfonate (commercially available under the tradename Tinopal SBM-GX by BASF). More preferably, the fluorescent brightener is disodium 4,4′-bis{[4-anilino-6-morpholino-s-triazin-2-yl]-amino}-2,2′-stilbenedisulfonate.

The brighteners may be added in particulate form or as a premix with a suitable solvent, for example nonionic surfactant, propanediol.

### Fabric Hueing Agents

A fabric hueing agent (sometimes referred to as shading, bluing or whitening agents) typically provides a blue or violet shade to fabric. Hueing agents can be used either alone or in combination to create a specific shade of hueing and/or to shade different fabric types. This may be provided for example by mixing a red and green-blue dye to yield a blue or violet shade. Hueing agents may be selected from any known chemical class of dye, including but not limited to acridine, anthraquinone (including polycyclic quinones), azine, azo (e.g., monoazo, disazo, trisazo, tetrakisazo, polyazo), including premetallized azo, benzodifurane and benzodifuranone, carotenoid, coumarin, cyanine, diazahemicyanine, diphenylmethane, formazan, hemicyanine, indigoids, methane, naphthalimides, naphthoquinone, nitro and nitroso, oxazine, phthalocyanine, pyrazoles, stilbene, styryl, triarylmethane, triphenylmethane, xanthenes and mixtures thereof.

Suitable fabric hueing agents include dyes, dye-clay conjugates, and organic and inorganic pigments. Suitable dyes also include small molecule dyes and polymeric dyes. Suitable small molecule dyes include small molecule dyes selected from the group consisting of dyes falling into the Colour Index (C.I.) classifications of Direct, Basic, Reactive or hydrolysed Reactive, Solvent or Disperse dyes for example that are classified as Blue, Violet, Red, Green or Black, and provide the desired shade either alone or in combination. Suitable polymeric dyes include polymeric dyes selected from the group consisting of polymers containing covalently bound (sometimes referred to as conjugated) chromogens, (dye-polymer conjugates), for example polymers with chromogens co-polymerized into the backbone of the polymer and mixtures thereof. Suitable polymeric dyes also include polymeric dyes selected from the group consisting of fabric-substantive colorants sold under the name of Liquitint® (Milliken, Spartanburg, S.C., USA), dye-polymer conjugates formed from at least one reactive dye and a polymer selected from the group consisting of polymers comprising a moiety selected from the group consisting of a hydroxyl moiety, a primary amine moiety, a secondary amine moiety, a thiol moiety and mixtures thereof. Suitable polymeric dyes also include polymeric dyes selected from the group consisting of Liquitint® Violet CT, carboxymethyl cellulose (CMC) covalently bound to a reactive blue, reactive violet or reactive red dye such as CMC conjugated with C.I. Reactive Blue 19, sold by Megazyme, Wicklow, Ireland under the product name AZO-CM-CELLULOSE, product code S-ACMC, alkoxylated triphenylmethane polymeric colourants, alkoxylated thiophene polymeric colourants, and mixtures thereof.

The aforementioned fabric hueing agents can be used in combination (any mixture of fabric hueing agents can be used).

### Encapsulates

An encapsulate may comprise a core, a shell having an inner and outer surface, said shell encapsulating said core. The core may comprise any laundry care adjunct, though typically the core may comprise material selected from the group consisting of perfumes; brighteners; hueing dyes; insectrepellants; silicones; waxes; flavors; vitamins; fabric softening agents; skin care agents in one aspect, paraffins; enzymes; anti-bacterial agents; bleaches; sensates; and mixtures thereof; and said shell may comprise a material selected from the group consisting of polyethylenes; polyamides; polyvinylalcohols, optionally containing other co-monomers; polystyrenes; polyisoprenes; polycarbonates; polyesters; polyacrylates; aminoplasts, in one aspect said aminoplast may comprise a polyureas, polyurethane, and/or polyureaurethane, in one aspect said polyurea may comprise polyoxymethyleneurea and/or melamine formaldehyde; polyolefins; polysaccharides, in one aspect said polysaccharide may comprise alginate and/or chitosan; gelatin; shellac; epoxy resins; vinyl polymers; water insoluble inorganics; silicone; and mixtures thereof.

Preferred encapsulates comprise perfume. Preferred encapsulates comprise a shell which may comprise melamine formaldehyde and/or cross linked melamine formaldehyde. Other preferred capsules comprise a polyacrylate based shell. Preferred encapsulates comprise a core material and a shell, said shell at least partially surrounding said core material, is disclosed. At least 75%, 85% or even 90% of said encapsulates may have a fracture strength of from 0.2 MPa to 10 MPa, and a benefit agent leakage of from 0% to 20%, or even less than 10% or 5% based on total initial encapsulated benefit agent. Preferred are those in which at least 75%, 85% or even 90% of said encapsulates may have (i) a particle size of from 1 microns to 80 microns, 5 microns to 60 microns, from 10 microns to 50 microns, or even from 15 microns to 40 microns, and/or (ii) at least 75%, 85% or even 90% of said encapsulates may have a particle wall thickness of from 30 nm to 250 nm, from 80 nm to 180 nm, or even from 100 nm to 160 nm. Formaldehyde scavengers may be employed with the encapsulates, for example, in a capsule slurry and/or added to a composition before, during or after the encapsulates are added to such composition.

Suitable capsules that can be made using known processes. Alternatively, suitable capsules can be purchased from Encapsys LLC of Appleton, Wis. USA. In a preferred aspect the composition may comprise a deposition aid, preferably in addition to encapsulates. Preferred deposition aids are selected from the group consisting of cationic and nonionic polymers. Suitable polymers include cationic starches, cationic hydroxyethylcellulose, polyvinylformaldehyde, locust bean gum, mannans, xyloglucans, tamarind gum, polyethyleneterephthalate and polymers containing dimethylaminoethyl methacrylate, optionally with one or more monomers selected from the group comprising acrylic acid and acrylamide.

### Perfumes

Non-limiting examples of perfume and perfumery components include, but are not limited to, aldehydes, ketones, esters, and the like. Other examples include various natural extracts and essences which can comprise complex mixtures of components, such as orange oil, lemon oil, rose extract, lavender, musk, patchouli, balsamic essence, sandalwood oil, pine oil, cedar, and the like. Finished perfumes can comprise extremely complex mixtures of such components. Finished perfumes may be included at a concentration ranging from about 0.01% to about 2% by weight of the detergent composition.

### Dye Transfer Inhibiting Agents

Dye transfer inhibiting agents are effective for inhibiting the transfer of dyes from one fabric to another during the cleaning process. Generally, such dye transfer inhibiting agents may include polyvinyl pyrrolidone polymers, polyamine N-oxide polymers, copolymers of N-vinylpyrrolidone and N-vinylimidazole, manganese phthalocyanine, peroxidases, and mixtures thereof. If used, these agents may be used at a concentration of about 0.0001% to about 10%, by weight of the composition, in some examples, from about 0.01% to about 5%, by weight of the composition, and in other examples, from about 0.05% to about 2% by weight of the composition.

### Chelating Agents

Suitable chelating agents include copper, iron and/or manganese chelating agents and mixtures thereof. Such chelating agents can be selected from the group consisting of phosphonates, amino carboxylates, amino phosphonates, succinates, polyfunctionally-substituted aromatic chelating agents, 2-pyridinol-N-oxide compounds, hydroxamic acids, carboxymethyl inulins and mixtures thereof. Chelating agents can be present in the acid or salt form including alkali metal, ammonium, and substituted ammonium salts thereof, and mixtures thereof. Other suitable chelating agents for use herein are the commercial DEQUEST series, and chelants from Monsanto, Akzo-Nobel, DuPont, Dow, the Trilon® series from BASF and Nalco.

### Suds Suppressors

Compounds for reducing or suppressing the formation of suds can be incorporated into the water-soluble unit dose articles. Suds suppression can be of particular importance in the so-called “high concentration cleaning process” and in front-loading style washing machines. Examples of suds suppressors include monocarboxylic fatty acid and soluble salts therein, high molecular weight hydrocarbons such as paraffin, fatty acid esters (e.g., fatty acid triglycerides), fatty acid esters of monovalent alcohols, aliphatic C₁₈-C₄₀ ketones (e.g., stearone), N-alkylated amino triazines, waxy hydrocarbons preferably having a melting point below about 100° C., silicone suds suppressors, and secondary alcohols.

Additional suitable antifoams are those derived from phenylpropylmethyl substituted polysiloxanes.

The detergent composition may comprise a suds suppressor selected from organomodified silicone polymers with aryl or alkylaryl substituents combined with silicone resin and modified silica, which is modified silica. The detergent compositions may comprise from about 0.001% to about 4.0%, by weight of the composition, of such a suds suppressor.

The detergent composition comprises a suds suppressor selected from: a) mixtures of from about 80 to about 92% ethylmethyl, methyl(2-phenylpropyl) siloxane; from about 5 to about 14% MQ resin in octyl stearate; and from about 3 to about 7% modified silica; b) mixtures of from about 78 to about 92% ethylmethyl, methyl(2-phenylpropyl) siloxane; from about 3 to about 10% MQ resin in octyl stearate; from about 4 to about 12% modified silica; or c) mixtures thereof, where the percentages are by weight of the anti-foam.

### Suds Boosters

If high sudsing is desired, suds boosters such as the C₁₀-C₁₆ alkanolamides may be used. Some examples include the C₁₀-C₁₄ monoethanol and diethanol amides. If desired, water-soluble magnesium and/or calcium salts such as MgCl₂, MgSO₄, CaCl₂, CaSO₄, and the like, may be added at levels of about 0.1% to about 2% by weight of the detergent composition, to provide additional suds and to enhance grease removal performance.

### Conditioning Agents

Suitable conditioning agents include high melting point fatty compounds. The high melting point fatty compound useful herein has a melting point of 25° C. or higher, and is selected from the group consisting of fatty alcohols, fatty acids, fatty alcohol derivatives, fatty acid derivatives, and mixtures thereof. Suitable conditioning agents also include nonionic polymers and conditioning oils, such as hydrocarbon oils, polyolefins, and fatty esters.

Suitable conditioning agents include those conditioning agents characterized generally as silicones (e.g., silicone oils, polyoils, cationic silicones, silicone gums, high refractive silicones, and silicone resins), organic conditioning oils (e.g., hydrocarbon oils, polyolefins, and fatty esters) or combinations thereof, or those conditioning agents which otherwise form liquid, dispersed particles in the aqueous surfactant matrix herein.

### Fabric Enhancement Polymers

Suitable fabric enhancement polymers are typically cationically charged and/or have a high molecular weight. The fabric enhancement polymers may be a homopolymer or be formed from two or more types of monomers. The monomer weight of the polymer will generally be between 5,000 and 10,000,000, typically at least 10,000 and preferably in the range 100,000 to 2,000,000. Preferred fabric enhancement polymers will have cationic charge densities of at least 0.2 meq/gm, preferably at least 0.25 meq/gm, more preferably at least 0.3 meq/gm, but also preferably less than 5 meq/gm, more preferably less than 3 meq/gm, and most preferably less than 2 meq/gm at the pH of intended use of the composition, which pH will generally range from pH 3 to pH 9, preferably between pH 4 and pH 8. The fabric enhancement polymers may be of natural or synthetic origin.

### Pearlescent Agent

Non-limiting examples of pearlescent agents include: mica; titanium dioxide coated mica; bismuth oxychloride; fish scales; mono and diesters of alkylene glycol. The pearlescent agent may be ethyleneglycoldistearate (EGDS).

### Hygiene and Malodour

Suitable hygiene and malodor active agents include zinc ricinoleate, thymol, quaternary ammonium salts such as Bardac®, polyethylenimines (such as Lupasol® from BASF) and zinc complexes thereof, silver and silver compounds, especially those designed to slowly release Ag⁺ or nano-silver dispersions.

### Buffer System

The water-soluble unit dose articles described herein may be formulated such that, during use in aqueous cleaning operations, the wash water will have a pH of between about 7.0 and about 12, and in some examples, between about 7.0 and about 11. Techniques for controlling pH at recommended usage levels include the use of buffers, alkalis, or acids, and are well known to those skilled in the art. These include, but are not limited to, the use of sodium carbonate, citric acid or sodium citrate, lactic acid or lactate, monoethanol amine or other amines, boric acid or borates, and other pH-adjusting compounds well known in the art.

The detergent compositions herein may comprise dynamic in-wash pH profiles. Such detergent compositions may use wax-covered citric acid particles in conjunction with other pH control agents such that (i) about 3 minutes after contact with water, the pH of the wash liquor is greater than 10; (ii) about 10 minutes after contact with water, the pH of the wash liquor is less than 9.5; (iii) about 20 minutes after contact with water, the pH of the wash liquor is less than 9.0; and (iv) optionally, wherein, the equilibrium pH of the wash liquor is in the range of from about 7.0 to about 8.5.

### Exemplary Iterations

According to an exemplary iteration, a laundry detergent composition or a unit dose article may comprise a particulate material. The particulate material may include one or more particles having an active component and a non-active component. Unit dose articles may include a water-soluble fibrous structure and the laundry detergent composition or at least the particulate material. The water-soluble fibrous structure may comprise a plurality of layers, and the particulate material or the laundry detergent composition may be dispersed between the plurality of layers. An exemplary non-active component may be from a filler, a carrier, a structurant, a builder, and combinations thereof. It is to be appreciated that other non-active components may also be employed. It is also to be appreciated that the active component may be any suitable active component, including but not limited to those described herein. Finally, it is to be appreciated that the laundry detergent composition or the unit dose article may comprise any suitable component, including but not limited to all components described herein.

The non-active component may have a dry particle size of from about 0.01 μm to about 50 μm, or from about 0.01 μm to about 20 μm, or from about 1 μm to about 15 μm, or from about 5 μm to about 10 μm. The dry particle size of the non-active component is measured before the non-active component is incorporated into the at least one particle. It is to be appreciated that upon exposure to water, the particle may optionally swell and/or may release all or a portion of the active component. For example, upon exposure to water at a temperature of from about 5° C. to 40° C., or about 10° C. to about 35° C. or about 15° C. to about 20° C., or about 10° C. to about 25° C., for a time of from about 5 minutes to about 60 minutes, or about 10 minutes to about 45 minutes, or about 15 minutes to about 30 minutes, or about 10 minutes to about 20 minutes, the at least one particle releases from about 1% to about 100%, or from about 5% to about 95%, or from about 10% to about 90%, or from about 20% to about 80%, or from about 30% to about 70%, or from about 40% to about 60%, or from about 50% of the active component and the remaining particle comprise non-active component and optionally some active component may have a particle size of from about 0.01 μm to about 75 μm, or about 0.01 μm to about 50 μm, or about 1 μm to about 40 μm, or about 5 μm to about 30 μm, or about 10 μm to about 20 μm, or about 0.01 μm to about 20 μm.

The non-active component may be soluble in water or partially soluble in water. The non-active component may have a solubility in water at 25 degrees Celsius of about 0 g/mL to about 10 g/mL, or about 1 g/mL to about 9 g/mL, or about 2 g/mL to about 8 g/mL, or about 3 g/mL to about 7 g/mL, or about 4 g/mL to about 6 g/mL, or about 5 g/mL. According to various iterations, the unit dose article, the particulate material, the plurality of particles, and/or the at least one particle may avoid inclusion of non-active components meeting any of the above-mentioned solubilities and having a particle size that is too big and, therefore, likely to cause residue on fabric. For example, according to various iterations, the at least one particle, the particulate material, and/or the unit does article may avoid any non-active components that are at least partially water-insoluble (or that meet any of the above-mentioned solubilities) and that also have an average dry particle size greater than about 50 μm, or greater than about 45 μm, or greater than about 40 μm, or greater than about 35 μm, or greater than about 30 μm, or greater than about 25 μm, or greater than about 20 μm, or greater than about 15 μm, or greater than about 10 μm, or greater than about 5 μm, or greater than about 1 μm, or greater than about 0.1 μm, or greater than about 0.01 μm. Typically, restricting the presence of non-active components that are at least partially water-insoluble having an average dry particle size of greater than about 20 μm is sufficient. According to various iterations, the non-active component may have a dry particle size of from 1 μm to about 10 μm.

It is possible for the non-active component to swell upon exposure to water. Thus, various embodiments may ensure that the non-active component has a swelling index of less than 2, or of from about 1 to about 2, or from about 1.2 to about 1.8, or from about 1.4 to about 1.6. The non-active component may have a swelling-index-adjusted particle size of from about 0.01 μm to about 50 μm, or from about 1 μm to about 40 μm, or from about 5 μm to about 35 μm, or from about 10 μm to about 30 μm, or from about 15 μm to about 25 μm, or about 20 μm.

According to various iterations, the non-active component may be present in the particle, in one or more of the plurality of particles, in the particulate material distinctly from the particle or particles, and/or in the unit dose article distinctly from the particle, the particles, or the particulate material. For example, the at least one particle may comprise from greater than 0% to about 70%, or about 5% to about 65%, or about 10% to about 60%, or about 15% to about 55%, or about 20% to about 50%, or about 25% to about 45%, or about 30% to about 40%, or about 10% by weight of the non-active component based on the total weight of the at least one particle. As another example, the at least one particle may comprise from about 30%, or from about 30 to about 100%, or from about 40 to about 90%, or from about 50 to about 80%, or from about 60 to about 70%, or from about 90% to about 100% by weight of the active component based on the total weight of the at least one particle. As still another example, the particulate material may comprise from about 60%, or about 60% to 100%, or about 65% to 95%, or about 60% to 90%, or about 70% to 85%, or about 75% to 80%, or from about 90% to about 100% by weight based on the total weight of the unit dose article of a total amount of all non-active component present in the unit dose article. Indeed, according to some iterations, the particulate material comprises all of the non-active component present in the unit dose article.

### EXAMPLES

The following examples are put forth to provide those of ordinary skill in the art with a complete disclosure and description of how to perform the methods, how to make, and how to use the compositions and compounds disclosed and claimed herein. Efforts have been made to ensure accuracy with respect to numbers (e.g., amounts, temperature, etc.), but some errors and deviations should be accounted for. The purpose of the following examples is not to limit the scope of the various iterations, but merely to provide examples illustrating specific iterations.

### Example 1

A purpose of this example is to demonstrate the preparation of four unit dose articles (Compositions 1 to 4). Compositions 1 and 2 contain particles that were prepared in a drum batch process to produce a mixed granulate (hereinafter, “production route 1”). Compositions 3 and 4 contain particles that were prepared in a fluidized bed process to produce a layered granulate (“production route 2”).

In the various compositions various components were employed, which are specified in detail in Table 1. Generally, in compositions 1-4, a non-woven fibrous web, (hereinafter, BW VT33 Web) was employed; a particulate laundry detergent composition comprising surfactants, chelant, polymer builder, and carbonate, (hereinafter, PolyAgg HT33) was employed; a suds suppressor was employed; an amylase was employed; a protease was employed; process aids, minors, and perfume were employed. The specific amounts of each component are listed in Table 1, along with the enzyme activity of the finished product. The material additions are shown at active material level in the finished product (FP).

TABLE 1

| | Composition | Composition | Composition | Composition |
|---|---|---|---|---|
| | 1 | 2 | 3 | 4 |
| NaAS (from | 3.76 | 3.76 | 3.76 | 3.76 |
| fiber) | | | | |
| Genapol T250 | 4.88 | 4.88 | 4.88 | 4.88 |
| (NI68-25)¹ | | | | |
| NaAE1S | 18.94 | 18.94 | 18.94 | 18.94 |
| (SLE1S, | | | | |
| from particle) | | | | |
| NaLAS (from | 17.17 | 17.17 | 17.17 | 17.17 |
| fiber | | | | |
| & particle) | | | | |
| PE20 (from | 7.28 | 7.28 | 7.28 | 7.28 |
| particle)⁴ | | | | |
| Sodium | 9.82 | 9.82 | 9.82 | 9.82 |
| Carbonate | | | | |
| (from particle) | | | | |
| Sodium Sulfate | 0.34 | 0.34 | 0.34 | 0.34 |
| (from particle) | | | | |
| Silica (from | 10.93 | 10.93 | 10.93 | 10.93 |
| particle) | | | | |
| Trilon M | 1.57 | 1.57 | 1.57 | 1.57 |
| Granule | | | | |
| SG³ (MGDA) | | | | |
| AcuSol 455 | 4.77 | 4.77 | 4.77 | 4.77 |
| (from | | | | |
| particle) ⁵ | | | | |
| Zeolite (from | 0.44 | 0.44 | 0.44 | 0.44 |
| Particle) | | | | |
| Citrate | 2.10 | 2.10 | 2.10 | 2.10 |
| (trisodium) | | | | |
| PVOH 505² | 4.97 | 4.97 | 4.97 | 4.97 |
| (from fiber) | | | | |
| PEOn10 (from | 0.43 | 0.43 | 0.43 | 0.43 |
| fiber) | | | | |
| PEOn60k | 0.07 | 0.07 | 0.07 | 0.07 |
| (from | | | | |
| fiber) | | | | |
| NaOH (from | 0.23 | 0.23 | 0.23 | 0.23 |
| particle) | | | | |
| AF8017⁶ | 1.36 | 1.36 | 1.36 | 1.36 |
| Suds | | | | |
| suppressor | | | | |
| Amylase | 0.00 | 2.955 | 0.00 | 0.00 |
| (production | | | | |
| route 1) ⁷ | | | | |
| 14.53 mg/g | | | | |
| Protease | 0.00 | 7.455 | 0.00 | 0.00 |
| (production | | | | |
| route 1) ⁷ | | | | |
| 33.17 mg/g | | | | |
| Amylase | 0.00 | 0.00 | 2.955 | 0.864 |
| (production | | | | |
| route 2) ⁸ | | | | |
| 48.1 mg/g | | | | |
| Protease | 0.00 | 0.00 | 7.455 | 1.682 |
| (production | | | | |
| route 2) ⁸ | | | | |
| 145.3 mg/g | | | | |
| Process aids, | To Balance | To Balance | To Balance | To Balance |
| Perfume, | | | | |
| Misc. & | | | | |
| Moisture | | | | |

¹Genapol T250 is a nonionic surfactant is commercially available from Clariant.
²Celvol PVOH 505 Mw 40,000-50,000 g/mol, 72-75% hydrolyzed, available from Kuraray America
³Trilon M SG is Methylglycinediacetic acid chelant commercially available from BASF.
⁴PE-20 is an ethoxylated polyethylene imine commercially available from BASF.
⁵ AcuSol 455 is a homopolymer of acrylic acid commercially available from Dow.
⁶ Suds suppressor is AF-8017 commercially available from Dow.
⁷ Drum batch process to give ‘mixed’ granulate.
⁸ Fluidized bed layered granulate.

Production route 1, the drum batch process for producing the mixed granulate, included combining and homogenizing the various solid components to create a uniform and consistent granular product. In this process, a large cylindrical drum or mixer was employed. The dry, raw materials were weighed and loaded into the drum. The drum was then rotated, using a variable speed and tilt mechanism, to ensure thorough mixing. During rotation, liquid components were sprayed onto the materials to facilitate adhesion. This controlled agitation and blending process continued until the desired level of uniformity was achieved. Once the mixture was homogeneous, it was discharged from the drum and was ready for testing as specified in Example 2.

Production route 2, the fluidized bed process, utilized a fluidized bed reactor or dryer. The dry, raw materials were introduced into the fluidized bed. Heated air or gas was then blown into the chamber from beneath, causing these materials to become suspended and to behave like a fluid. Additional liquid materials were then introduced through nozzles above the fluidized bed. As these additional liquid materials were sprayed or poured onto the fluidized core, they adhered to form distinct layers on the original raw materials. The controlled flow of the gas and the manipulation of process parameters like temperature, airflow, and spray rate determine the thickness and composition of each layer. This process continued until the desired layered granulate structure was achieved. Once complete, the product was removed and was ready for testing as specified in Example 2.

### Example 2

A purpose of this example is to demonstrate the impact of enzyme granulate production route on fabric residues. Three external replicates were completed for each composition. 1000 ml of tap water was measured into each tergotometer pot and cooled to 10° C. or heated to 25° C. 1.22 g of the composition being tested was then added and a timer started. After 20 minutes of dissolution, the full wash solution was taken from each tergotometer pot and filtered through the black fabric using a vacuum pump, 3-piece, 9 cm diameter Büchner funnel, and a PYREX® flask with a side arm. Table 2 summarizes the materials employed.

TABLE 2

| Material | Details | Source (if applicable) |
|---|---|---|
| Wash Equipment | Tergotometer | Copley Scientific Limited, |
| | | Colwick Quays Business Park, |
| | | Road No. 2, Nottingham, |
| | | NG4 2JY, |
| | | United Kingdom |
| Wash Volume | 1000 ml | |
| Water Hardness | Tap water with | |
| | about 7 gpg | |
| | hardness | |
| Water Temperature | 10° C. and 25° C. | |
| Detergent addition | 1.22 g | |
| Black fabric | C70 | Empirical Manufacturing |
| | | Company, 7637 Production |
| | | Drive, Cincinnati, Ohio |
| | | 45237, USA. |
| Black fabric | Vacuum pump | General Laboratory (with trap) |
| filtration | Buckner funnel | 3-piece, glass, 9 cm diameter |
| | Flask | 1L+ Pyrex with side-arm. |
| Image and color | Image analysis | DIGIEYE ® system for textiles |
| of residue | | VeriVide Limited, Quartz Close, |
| | | Warrens Business Park, |
| | | Enderby, Leicester LE19 4SG |
| | | United Kingdom |

At the start of each test the black fabrics were weighed using a balance, so residue weight could be determined gravimetrically. Fabrics were left to dry at room temp over night before re-weighing and analyzing the CIELAB color space of any residue deposited on the fabric using the DIGI-EYE®.

The Lab Color Space (CIELAB color space): also referred to as L*a*b* is a color space defined by the International Commission on Illumination (CIE) in 1976. It expresses color as three values: L* for perceptual lightness, and a* and b* for the four unique colors of human vision: red, green, blue, and yellow. L* may range from 0 (black) to 100 (white); a* specifies redness-greenness and may range from negative values (green) to positive values (red); and b* specifies yellowness-blueness and may range from negative values (blue) to positive values (yellow). The CIELAB color space is device-independent, meaning that it is not tied to any device or display technology. This makes it a good choice for applications where color needs to be accurately represented on a variety of devices.

The color difference between two colors may be calculated by measuring the L*a*b* values for each color. The value of ΔE*ab, as specified in the following formula, is a measure of the perceived color difference between the two colors. The higher the value of ΔE*ab, the greater the perceived color difference.

$$Δ E * ab = √ ( {( Δ L * )}^{2} + {( Δ a * )}^{2} + {( Δ b * )}^{2} )$$

where ΔL*, Δa*, and Δb* are the differences in the L*, a*, and b* values between the two colors.

$$Δ {L}^{*} = {L}_{washed} - {L}_{initial} \\ Δ {a}^{*} = {a}_{washed} - {a}_{initial} \\ Δ {b}^{*} = {b}_{washed} - {b}_{initial}$$

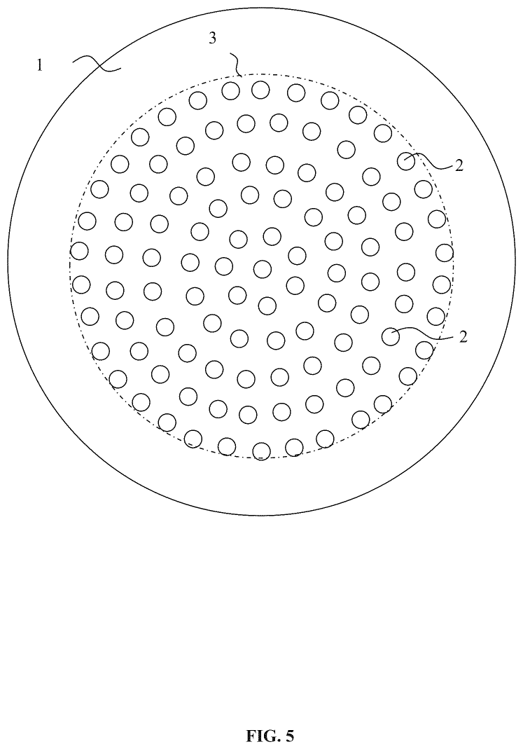

With reference to FIG. 5A, L*, a*, and b* measurements were taken by analyzing a test fabric 1 comprising one or more residue portions 2. The measurements were taken over the full area encompassed by a perimeter 3 surrounding all of the one or more residue portions 2 on the fabric 1. The perimeter 3 was a circle having a radius of about 450 mm.

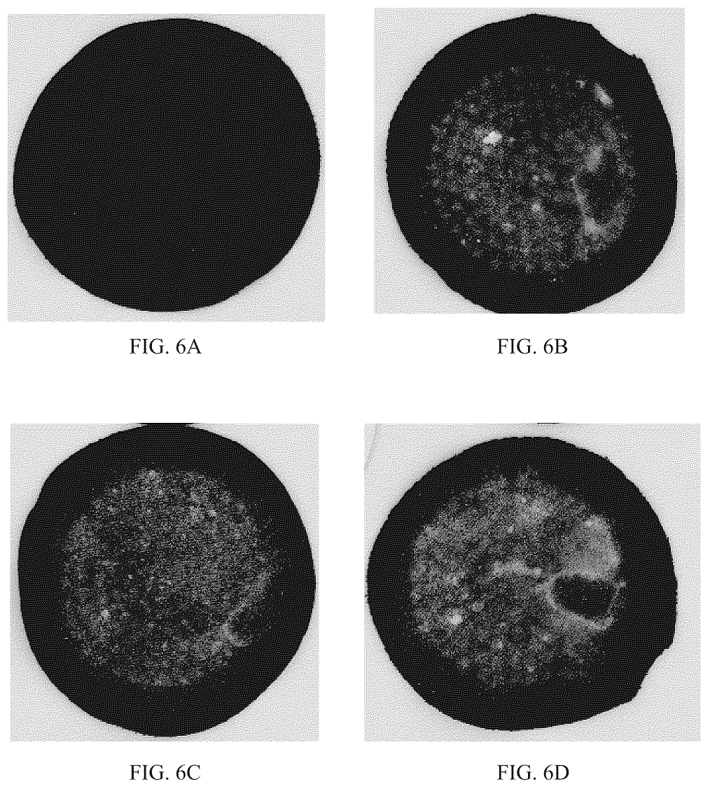

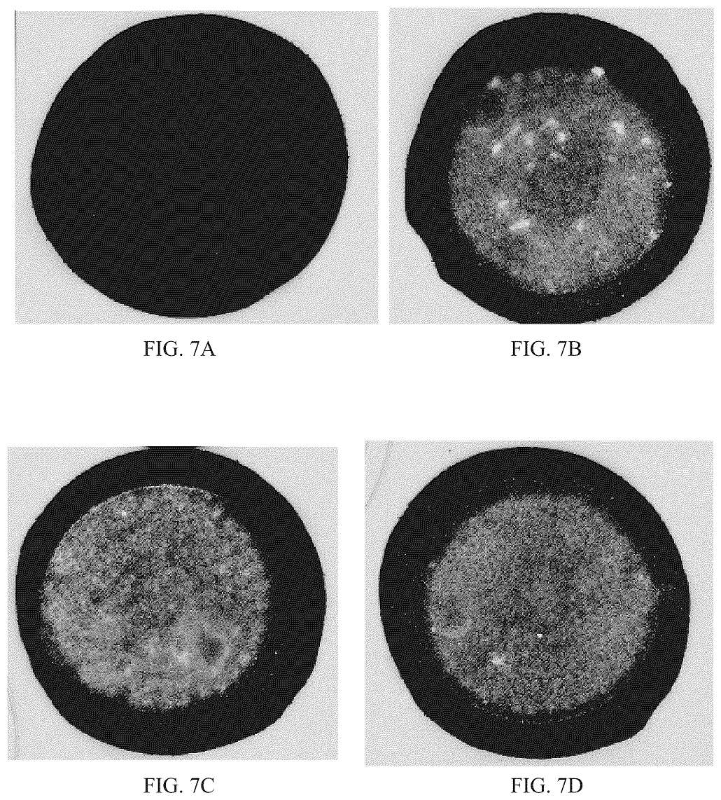

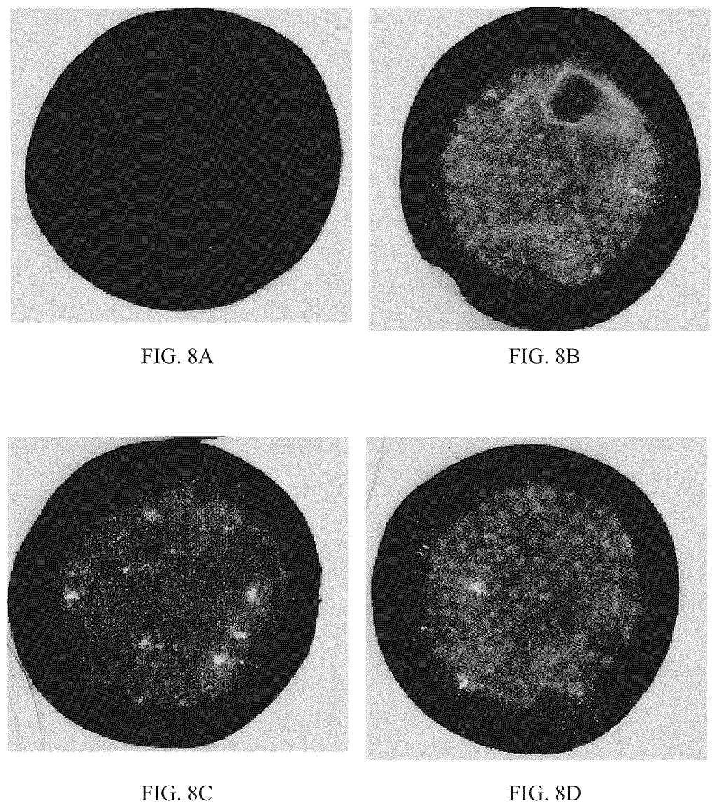

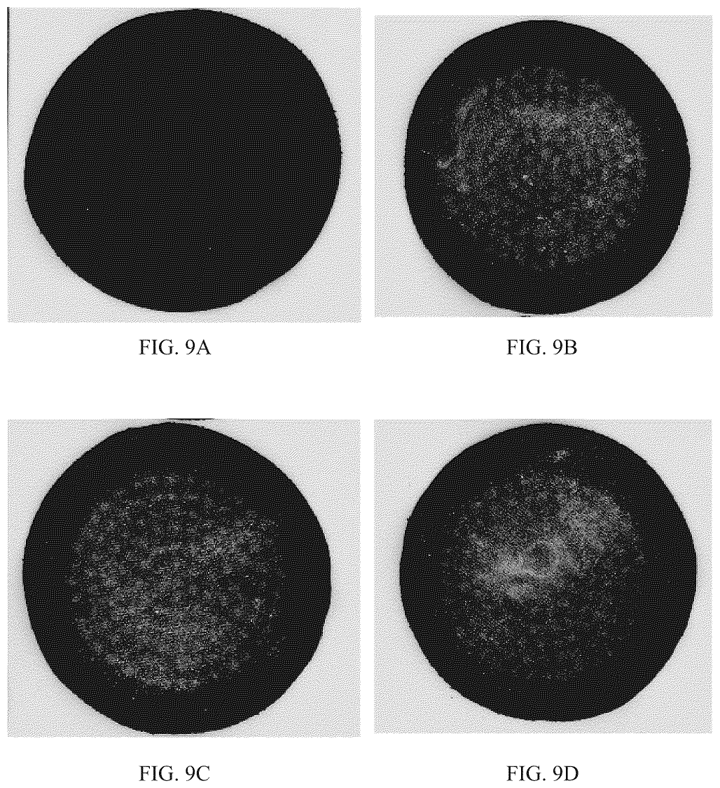

FIG. 6A, 7A, 8A, 9A are photographs of untreated/unstained samples of C70 black fabric, establishing the initial conditions of the fabric samples used. FIGS. 6B, 6C, and 6D are photographs of first, second, and third replicates of a C70 black fabric after exposure to Composition 1 at 10° C. FIGS. 7B, 7C, and 7D are photographs of first, second, and third replicates of a C70 black fabric after exposure to Composition 2 at 10° C. FIGS. 8B, 8C, and 8D are photographs of first, second, and third replicates of a C70 black fabric after exposure to Composition 3 at 10° C. FIGS. 9B, 9C, and 9D are photographs of first, second, and third replicates of a C70 black fabric after exposure to Composition 4 at 10° C. Table 3, summarizes the results of the measured level of residues per leg by weight (g) and by color (ΔE*ab) calculated as described above for the samples tested at 10° C.

TABLE 3
(10° C. results)

| | | | Delta E | |
|---|---|---|---|---|
| | Residue weight (g) | | (Average of | |
| | (Average of 3 reps) | St Dev | 3 reps) | St Dev |
| Composition 1 | 0.15 | 0.0058 | 25.12 | 2.59 |
| Composition 2 | 0.18 | 0.0153 | 34.64 | 1.48 |
| Composition 3 | 0.15 | 0.0416 | 25.37 | 3.98 |
| Composition 4 | 0.13 | 0.0416 | 21.85 | 0.22 |

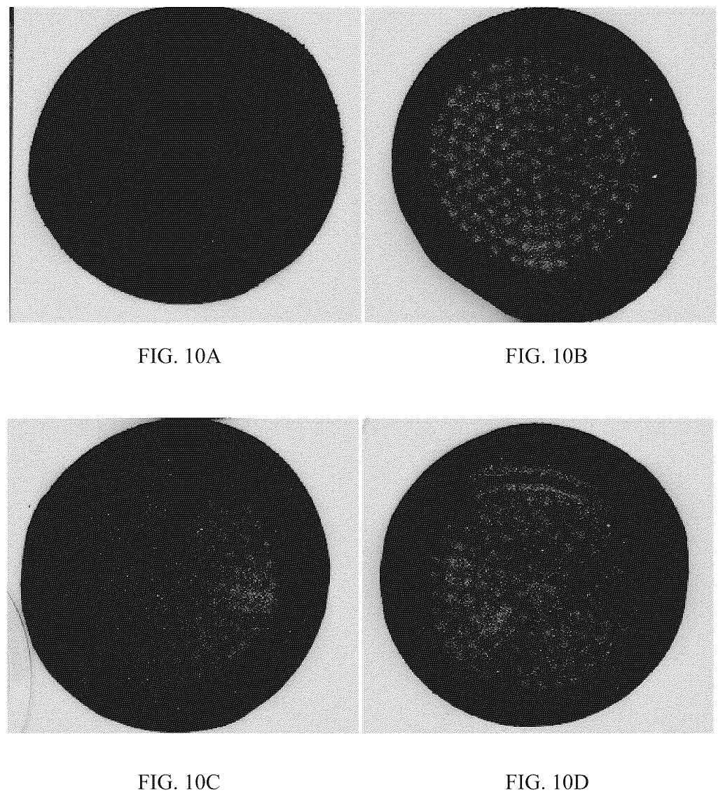

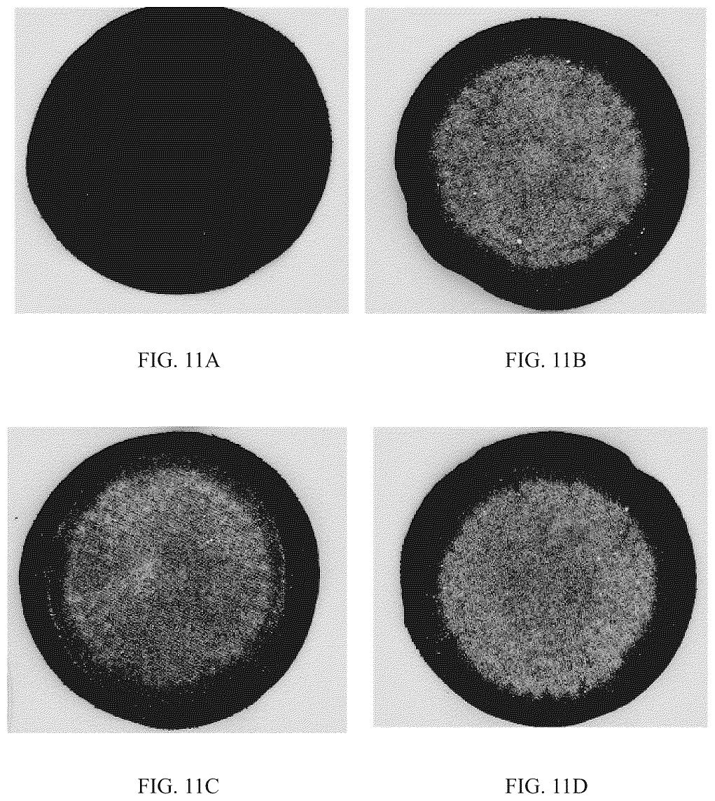

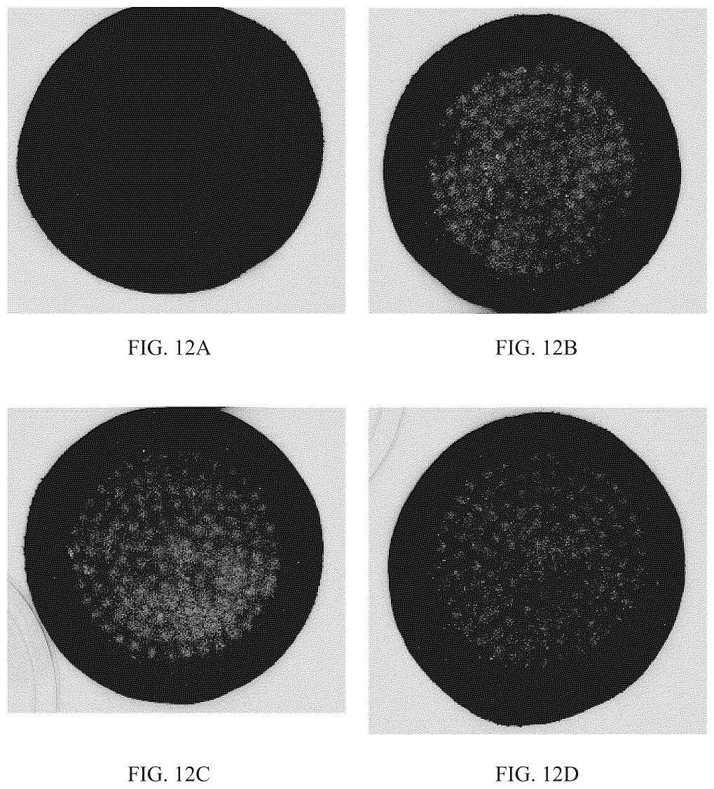

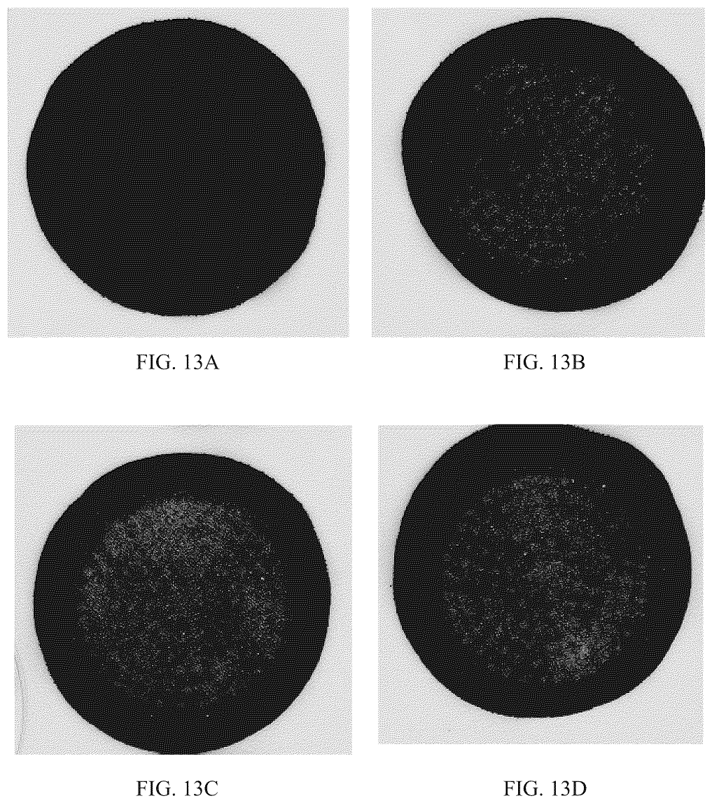

FIGS. 10A, 11A, 12A, and 13A are photographs of untreated/unstained samples of C70 black fabric, establishing the initial conditions of the fabric samples used. FIGS. 10B, 10C, and 10D are photographs of first, second, and third replicates of a C70 black fabric after exposure to Composition 1 at 25° C. FIGS. 1B, 11C, and 11D are photographs of first, second, and third replicates of a C70 black fabric after exposure to Composition 2 at 25° C. FIGS. 12B, 12C, and 12D are photographs of first, second, and third replicates of a C70 black fabric after exposure to Composition 3 at 25° C. FIGS. 13B, 13C, and 13D are photographs of first, second, and third replicates of a C70 black fabric after exposure to Composition 4 at 25° C. Table 4, summarizes the results of the measured level of residues per leg by weight (g) and by color (ΔE*ab) calculated as described above for the samples tested at 25° C.

TABLE 4
(10° C. results)

| | | | Delta E | |
|---|---|---|---|---|
| | Residue weight (g) | | (Average of | |
| | (Average of 3 reps) | St Dev | 3 reps) | St Dev |
| Composition 1 | 0.08 | 0.0153 | 14.53 | 2.19 |
| Composition 2 | 0.14 | 0.0058 | 33.50 | 1.69 |
| Composition 3 | 0.09 | 0.0153 | 20.23 | 3.32 |
| Composition 4 | 0.07 | 0.0058 | 16.58 | 2.71 |

The examples demonstrate the efficacy of fluidized bed layered granulates within a laundry detergent powder/web compositions to deliver less residues when tested at equal weight (composition 3) vs Drum batch process to give ‘mixed’ granulate (composition 2) and when tested at equal active enzyme (composition 4) vs Drum batch process to give ‘mixed’ granulate (composition 2).

### Example 3

A purpose of this example is to demonstrate residues left on black cotton and polyester fabrics by a variety of insoluble fillers (non-active components) having various particle sizes. The insoluble fillers included a zeolite having a dry particle size of 4 μm, precipitated calcium carbonate having a dry particle size of 7 μm, magnesium carbonate (MgCO₃) having a dry particle size of 15 μm, microcrystalline cellulose having a dry particle size of 20 μm, and microcrystalline cellulose having a dry particle size of 50 μm. 0.04 g of each filler per 800 mls 6 gpg water was used in each test. The solution was filtered through the fabric using a vacuum pump, 3-piece, 9 cm diameter Buchner funnel, and a PYREX® flask with a side arm. Three replicates were completed for each material.

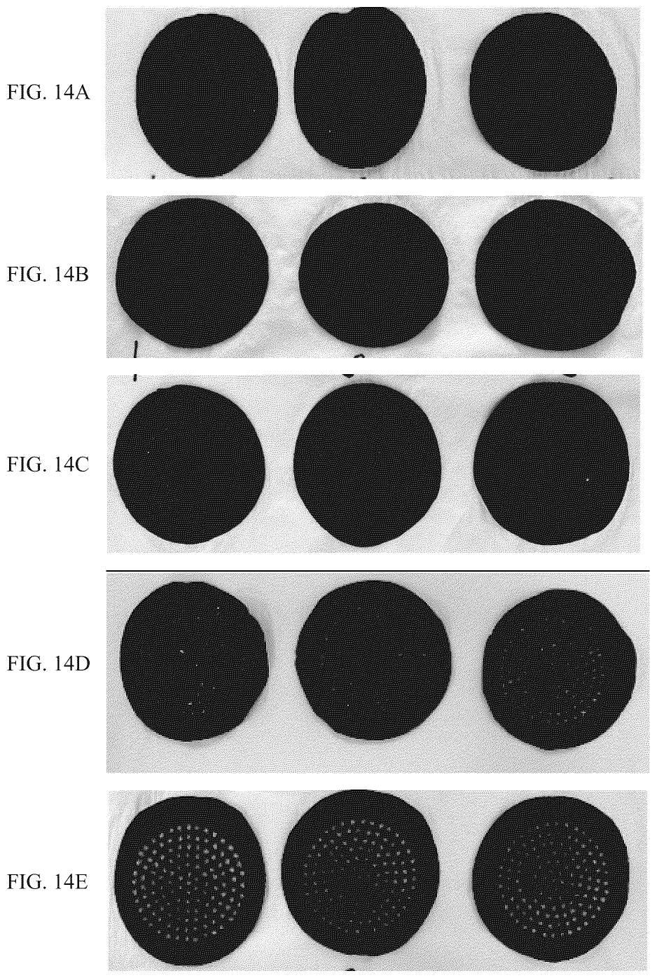

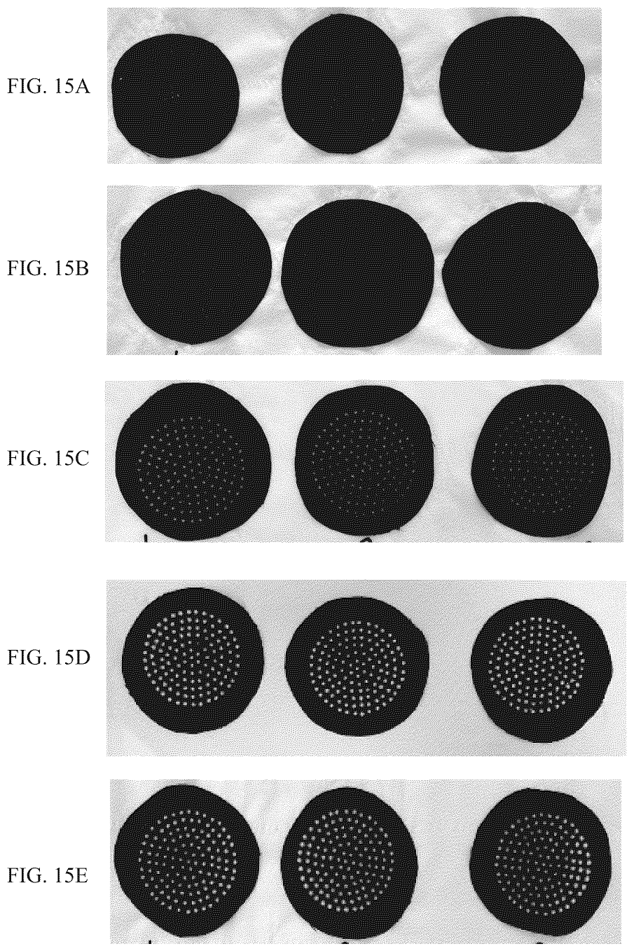

FIG. 14A and FIG. 15A each show photographs of three replicates of a technical black cotton fabric and a consumer black polyester fabric, respectively, after exposure to a zeolite having a dry particle size of 4 μm.

FIG. 14B and FIG. 15B each show photographs of three replicates of a technical black cotton fabric and a consumer black polyester fabric, respectively, after exposure to precipitated calcium carbonate having a dry particle size of 7 μm.

FIG. 14C and FIG. 15C each show photographs of three replicates of a technical black cotton fabric and a consumer black polyester fabric, respectively, after exposure to magnesium carbonate (MgCO₃) having a dry particle size of 15 μm.

FIG. 14D and FIG. 15D each show photographs of three replicates of a technical black cotton fabric and a consumer black polyester fabric, respectively, after exposure to microcrystalline cellulose having a dry particle size of 20 μm.

FIG. 14E and FIG. 15E each show photographs of three replicates of a technical black cotton fabric and a consumer black polyester fabric, respectively, after exposure to microcrystalline cellulose having a dry particle size of 50 μm.

Based on visual inspection of these figures, the polyester fabric exhibits more residues than the cotton technical test fabric. Suggesting its pore size is smaller for the entrapment of insoluble particles. Insoluble particles of 4 μm or less are proven to leave no visible residues on both cotton and polyester fabrics. Polyester shows visible residues for particle sizes greater than about 7 μm. Cotton shows visible residues for particle sizes greater than about 20 um.

### Contemplated Examples

Example A: A unit dose article comprising: a water-soluble fibrous structure having a plurality of layers and a plurality of particles dispersed between the plurality of layers, wherein each of the plurality of particles comprises an active component and a non-active component, and wherein upon exposure to water at a temperature of 5° C. to 40° C., preferably about 10° C. to about 25° C. for a time of about 5 minutes to about 60 minutes, preferably about 10 minutes to about 20 minutes, at least about 50% to about 100%, preferably about 70% to 90% of the plurality of particles release at least some of the active component, and have a particle size of from about 0.01 μm to about 50 μm.

Example A1: A laundry detergent composition, comprising a particulate material comprising at least one particle, the at least one particle comprising: an active component and an non-active component, having a dry particle size of from about 0.01 μm to about 20 μm.

### FURTHER DEFINITIONS AND CROSS-REFERENCES

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular iterations of the present disclosure have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A unit dose article comprising
a water-soluble fibrous structure, and
a particulate material comprising at least one particle comprising a first component, wherein the first component is a water-soluble active component, and a second component, wherein the second component comprises an inactive component, s at least partially water-insoluble and has a dry particle size of from about 0.01 μm to about 20 μm.

2. The unit dose article of claim 1, wherein the second component is a non-active component.

3. The unit dose article according to claim 1, wherein upon exposure to water at a temperature of 5° C. to 40° C., for a time of about 5 minutes to about 60 minutes, the at least one particle releases at least some of the first component having, and has a particle size of from about 0.01 μm to about 50 μm.

4. The unit dose article according to claim 1, wherein the particulate material does not comprise any second components, preferably non-active components, that are at least partially water-insoluble and that have an average dry particle size greater than about 50 μm, preferably about 20 μm.

5. The unit dose article according to claim 1, wherein the unit dose article does not comprise any second components that have an average dry particle size greater than about 50 μm.

6. The unit dose article according to claim 1, wherein the at least one particle comprises from greater than 0% to about 70% by weight of the second component based on the total weight of the at least one particle.

7. The unit dose article according to claim 1, wherein the at least one particle comprises from about 30% by weight of the first component based on the total weight of the at least one particle.

8. The unit dose article according to claim 1, wherein the particulate material comprises from about 60% by weight based on the total weight of the unit dose article of a total amount of all second component.

9. The unit dose article according to claim 1, wherein the water-soluble fibrous structure comprises a plurality of layers, and wherein the particulate material is dispersed between the plurality of layers.

10. The unit dose article according to claim 1, wherein the second component has a dry particle size of from 1 μm to about 10 μm.

11. The unit dose article according to claim 1, wherein the second component exhibits a swelling index of less than 2.

12. The unit dose article according to claim 1, wherein the second component exhibits a swelling-index-adjusted particle size of from about 0.01 μm to about 50 μm.

13. The unit dose article according to claim 1, wherein the second component exhibits a solubility in water of about 0 g/mL to about 10 g/mL at about 25 degrees C.

14. The unit dose article according to claim 1, wherein the second component comprises a crystalline material.

15. The unit dose article according to claim 14, wherein the second component comprises a filler, a carrier, a structurant, a builder, or combinations thereof.

16. The unit dose article according to claim 1, wherein the first component comprises at least one of: an enzyme, a surfactant, inorganic dissolution aid, a rheology modifier, or a combination thereof.

17. The unit dose article according to claim 16, wherein the first component comprises a surfactant and wherein the surfactant comprises linear alkylbenzene sulfonate, alkylethoxylated sulfate, or a combination thereof.

18. The unit dose article according to claim 17, wherein the first component comprises linear alkylbenzene sulfonate and alkyethoxylated sulfate, and wherein a ratio of linear alkylbenzene sulfonate to alkylethoxylated sulfate of greater than 1.

19. The unit dose article according to claim 1, further comprising a perfume microcapsule, a hueing agent, a bleaching agent, an enzyme, an aversive agent, a nonionic surfactant, or a combination thereof.

20. The unit dose article according to claim 1, comprising a printed area on an outer surface thereof.
